(19) United States
(12) Patent Application Publication
(10) Pub. No.: US 2025/0178838 A1
(43) Pub. Date: Jun. 5, 2025

(54) Automated Storage and Retrieval System

(71) Applicant: Staples, Inc., Framingham, MA (US)

(72) Inventors: Harsha Amba, Tampa, FL (US); Aum Patel, Tampa, FL (US)

(21) Appl. No.: 18/970,648

(22) Filed: Dec. 5, 2024

Related U.S. Application Data
(60) Provisional application No. 63/606,504, filed on Dec. 5, 2023.

(51) Int. Cl. B65G 1/137; B65G 1/04; B65G 1/10

(52) U.S. Cl. CPC B65G 1/1378; B65G 1/0478; B65G 1/10

(57) ABSTRACT

A system may include a set of buffer shelves holding one or more mobile storage units, each of the one or more mobile storage units holding at least one item. A system may include a mobile robot including a body structure supporting a handling mechanism and a translation motor, the translation motor moving the body structure to a first buffer shelf of the set of buffer shelves, the handling mechanism moving a first mobile storage unit of the one or more mobile storage units from the first buffer shelf to a staging area. A system may include a picking station including the staging area at which the first mobile storage unit is held, a picking location at which a carton is held, and a picking mechanism for moving a first item from the first mobile storage unit to the carton.

### BACKGROUND

This application relates to warehouse fulfillment systems. For example, this application relates to an automated, efficient buffer system that buffers movement of items between picking stations and a storage area.

Existing systems for fulfilling orders pick items into cartons one-by-one, often using human pickers that seek out items in a warehouse and then place them into shipping cartons. Human based systems result in errors, fatigue, and increased task time.

Some fulfillment systems use robots to transport shelves holding a plurality of items from a storage area to a picking station where a human places picks items from the shelves. Unfortunately, these more-automated systems typically use just-in-time transportation of the shelves to the picking station, which results in downtime, increased quantities or conflicts for robots, and many other issues. Furthermore, these systems tend to be inflexible, are only useful in limited situations, or are only useful for single item orders. These previous systems required human picking and/or high complexity, and the quantity of robots required were expensive, deployed slowly, and required substantial amounts of maintenance. Unfortunately, systems using just-in-time delivery of items to the picking station also create traffic or sequencing issues with delivery mechanisms, such as automated guided vehicles.

### SUMMARY

An automated storage and retrieval system can be configured to perform particular operations or actions by virtue of having software, firmware, hardware, or a combination of them installed on the system that in operation causes or cause the system to perform the actions. Similarly, various hardware components are described that improve picking technologies, including over those issues described in the Background.

In some aspects, the techniques described herein relate to a system including: a set of buffer shelves holding one or more mobile storage units, each of the one or more mobile storage units holding at least one item; a mobile robot including a body structure supporting a handling mechanism and a translation motor, the translation motor moving the body structure to a first buffer shelf of the set of buffer shelves, the handling mechanism moving a first mobile storage unit of the one or more mobile storage units from the first buffer shelf to a staging area; and a picking station including the staging area at which the first mobile storage unit is held, a picking location at which a carton is held, and a picking mechanism for moving a first item from the first mobile storage unit to the carton.

In some aspects, the techniques described herein relate to a system, wherein: the set of buffer shelves include a plurality of buffer shelves arranged in a grid of at least two shelves wide by at least two shelves tall.

In some aspects, the techniques described herein relate to a system, wherein: each of the plurality of buffer shelves is open at two opposing sides, the mobile robot accessing each of the plurality of buffer shelves at a first side of the two opposing sides, an automated guided vehicle accessing each of the plurality of buffer shelves at a second side of the two opposing sides, the automated guided vehicle being adapted to transport the one or more mobile storage units from a storage area to the set of buffer shelves.

In some aspects, the techniques described herein relate to a system, wherein: each of the plurality of buffer shelves include a vertical post supporting at least two brackets, the at least two brackets supporting the one or more mobile storage units from two sides of the one or more mobile storage units while leaving a space open underneath the one or more mobile storage units and between the at least two brackets.

In some aspects, the techniques described herein relate to a system, further including: a support rail running horizontally along a face of the set of buffer shelves, the mobile robot being coupled with the support rail, the support rail providing guidance to the mobile robot.

In some aspects, the techniques described herein relate to a system, further including: a power rail running along the face of the set of buffer shelves, the power rail providing electrical power to the mobile robot using one or more contact points between the mobile robot and the power rail.

In some aspects, the techniques described herein relate to a system, wherein: the mobile robot includes a mast extending vertically from the body structure, the mast supporting the handling mechanism, the handling mechanism moving vertically along the mast, the handling mechanism of the mobile robot accessing the first buffer shelf based on a position of the mobile robot horizontally along the support rail and based on a position of the handling mechanism vertically along the mast.

In some aspects, the techniques described herein relate to a system, wherein: the handling mechanism includes a support platform that translates horizontally away from the mast in a first direction when retrieving the first mobile storage unit from the first buffer shelf and translates horizontally away from the mast in a second direction when placing the first mobile storage unit at the staging area.

In some aspects, the techniques described herein relate to a system, wherein: the staging area includes a conveyor adapted to move the first mobile storage unit from a first location at which the first mobile storage unit is received from the mobile robot and to move the first mobile storage unit closer to the picking station.

In some aspects, the techniques described herein relate to a system, further including: an automated guided vehicle that moves freely within an operating environment to retrieve the one or more mobile storage units from one or more locations in a storage area, the mobile robot being coupled to a support rail parallel to a face of the set of buffer shelves and moves the one or more mobile storage units between the set of buffer shelves and the staging area.

In some aspects, the techniques described herein relate to a method including: instructing, by one or more processors, a robot to remove a first mobile storage unit from a set of buffer shelves using a handling mechanism, the first mobile storage unit holding at least one item; instructing, by the one or more processors, the robot to place the first mobile storage unit at a staging area using the handling mechanism; instructing, by the one or more processors, a picking mechanism at a picking station to perform a pick task including removing a first item from the first mobile storage unit; determining, by the one or more processors, that the pick task has been completed at the picking station using the first mobile storage unit; instructing, by the one or more processors, the robot to remove the first mobile storage unit from the staging area using the handling mechanism; and instructing, by the one or more processors, the robot to place the first mobile storage unit on the set of buffer shelves.

In some aspects, the techniques described herein relate to a method, further including: instructing, by the one or more processors, one or more automated guided vehicles to transport the first mobile storage unit from a storage area and place the first mobile storage unit on a first buffer shelf of the set of buffer shelves.

In some aspects, the techniques described herein relate to a method, further including: determining, by the one or more processors, that the first mobile storage unit is not needed for a subsequent pick task at the picking station; and responsive to determining that the first mobile storage unit is not needed, instructing, by the one or more processors, the one or more automated guided vehicles to retrieve the first mobile storage unit from the set of buffer shelves and transport it to the storage area.

In some aspects, the techniques described herein relate to a method, further including: determining, by the one or more processors, a set of pick tasks for items in orders assigned to a picking station; determining, by the one or more processors, a set of mobile storage units holding the items in the orders, the set of mobile storage units including the first mobile storage unit; and instructing, by the one or more processors, one or more automated guided vehicles to transport the set of mobile storage units from a storage area to the set of buffer shelves.

In some aspects, the techniques described herein relate to a method, wherein instructing the picking mechanism at the picking station to perform the pick task includes: instructing a robotic arm to remove the first item from the first mobile storage unit and place it in a carton at a picking location.

In some aspects, the techniques described herein relate to a method, wherein instructing the picking mechanism at the picking station to perform the pick task includes: instructing a human picker via human interface device to remove the first item from the first mobile storage unit and place it in a carton at a picking location.

In some aspects, the techniques described herein relate to a method, wherein instructing the picking mechanism at the picking station to perform the pick task includes: instructing the picking mechanism to remove a second item from the first mobile storage unit and place it in a carton with the first item.

In some aspects, the techniques described herein relate to a method, further including: instructing, by the one or more processors, the robot to navigate horizontally along a support rail to a location of a defined buffer shelf; instructing, by the one or more processors, the robot to transport a second mobile storage unit from the location of the defined buffer shelf to the staging area using the handling mechanism; and instructing, by the one or more processors, the picking mechanism at the picking station to perform a second pick task including removing a second item from the second mobile storage unit and place the second item into a carton with the first item from the first mobile storage unit.

In some aspects, the techniques described herein relate to a method, further including: instructing, by the one or more processors, the robot to raise the handling mechanism vertically along a mast of the robot to a height of the defined buffer shelf; instructing, by the one or more processors, the robot to extend the handling mechanism along a first horizontal direction to retrieve the second mobile storage unit from the defined buffer shelf; and instructing, by the one or more processors, the robot to extend the handling mechanism along a second horizontal direction and lower the handling mechanism to place the second mobile storage unit at the staging area.

In some aspects, the techniques described herein relate to a system including: one or more processors; and a memory storing instructions that, when executed by the one or more processors, causes the system to perform operations including: instructing a robot to remove a first mobile storage unit from a set of buffer shelves using a handling mechanism, the first mobile storage unit holding at least one item; instructing the robot to place the first mobile storage unit at a staging area using the handling mechanism; instructing a picking mechanism at a picking station to perform a pick task including removing a first item from the first mobile storage unit; determining that the pick task has been completed at the picking station using the first mobile storage unit; instructing the robot to remove the first mobile storage unit from the staging area using the handling mechanism; and instructing the robot to place the first mobile storage unit on the set of buffer shelves.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 depicts an example system and data communication flow for implementing an automated storage and retrieval buffer system.

FIG. 2 illustrates an example layout of a portion of a fulfillment center that may be used in the automated robotic fulfillment system.

FIG. 3 is a flowchart of an example method for automated robotic picking and buffering using an automated storage and retrieval buffer system.

FIGS. 4A-4D illustrate various views of an example picking system in which an automated storage and retrieval buffer system is used.

FIGS. 5A and 5B illustrate various views of example automated storage and retrieval buffer system buffer shelves.

FIGS. 6A-6G illustrate various views of an example automated storage and retrieval buffer system robot.

FIGS. 7A and 7B illustrate views of an example automated guided vehicle that may be used to transport mobile storage units to automated storage and retrieval buffer system buffer shelves.

FIG. 8 is a block diagram illustrating an example computing system.

### DESCRIPTION

The technology described herein may be used in an automatic, robotic replenishment, organizing, or fulfillment system in a warehouse. For instance, the technology described herein may be applied in various contexts to move items from first containers into second containers, such as from storage units into shipping cartons. It should be noted that the configurations may take various forms and have various materials without departing from the scope of this disclosure.

In some implementations, a single loading point, sequential loading (e.g., on a conveyor belt), or other means may be used for feeding items or mobile storage units holding items to a picking station where the items may be picked into, for instance, shipping cartons. One or multiple automated guided vehicles (AGVs) may automatically retrieve objects (items or mobile storage units) from a storage area and bring them to the picking station where the items are picked into totes or shipping cartons to fulfill orders. In some implementations, the AGVs may be incapable of placing the objects at the picking station (e.g., on a conveyor). In some implementations, the AGVs may experience scheduling, traffic, movement, or other issues when attempting to bring the objects to the picking station.

Accordingly, to improve the speed, timeliness, and efficiency of bringing objects to picking stations, the technology described herein may use a buffer system between a storage area of a warehouse. The buffer system may include buffer shelves (or other storage or buffer areas) that may be accessible to one or multiple AGVs (e.g., simultaneously) to place objects at the shelves and from which the object may be moved to one or more picking stations using an ASRS (Automated Storage and Retrieval System) robot (which may be referred to herein simply as ASRS robot). While some implementations of this system may increase overall complexity and provide an extra step for completion of pick tasks, it improves overall flow, efficiency, and asset utilization, as noted elsewhere herein.

The ASRS may be designed to assist and fully automate current bin picking equipment. Its goal may be to act as a medium between the totes (e.g., bins, pallets, mini-pallets, bins, or other containers) that are being brought by the AGVs or other equipment to a picking station that is configured to pick items from the totes. This system may eliminate or reduce the need for associates to manually get totes from storage and return them for replenishment. The buffer shelves may store totes for upcoming orders that are directed to the picking station and also the totes that have been returned by the picking station after order completion. In some implementations, the ASRS robot may include a telescopic base that slides under a tote and lifts it up to retrieve it and does the opposite for storing it.

The described technology may combine with various types of AGVs and/or picking stations in order to improve their efficiency, utilization, and redundancy, among other improvements.

The described technology and system may act as a dynamic buffer where the picker (e.g., a robotic arm, human, or other device) can pick a SKU (e.g., an item having a certain stock keeping unit) for an order more efficiently. The technology improves the picking process, for example, as multiple items (e.g., in totes/mobile storage units) from the system can be transported to the buffer system at one time and the effort (e.g., by automatic guided vehicles) required to move the tote to a corresponding pick cell is reduced.

The technology described herein improves multi-line (e.g., where multiple items and/or SKUs are picked for a single order) picking in a robotic environment, for example, in a partially or completely automated picking system for multiline picking. The technology reduces costs, may be deployed faster in new fulfillment centers, and requires little maintenance. Additionally, its design is robust and results in fewer errors and alerts than previous systems.

Various operations, features, and components for implementing the technology are described throughout this disclosure, such as in reference to the examples illustrated in the figures.

The technology described herein relates to an automated system comprising various software and hardware devices, for example, an automated robotic picking system, an automated storage and retrieval system, or other technology. The technology may include beneficial configurations, operations, features, and interactions. Among other benefits, the technology described herein improves upon that described in the Background Section. For instance, the technology provides robotic devices, systems, methods, and other aspects that can more efficiently perform picks.

In some implementations, the technology may provide integration, coordination, and control of various systems to intelligently move items and reduce human interaction, which increases speed and accuracy.

In some instances, the technology may include various computing devices or controllers coupled with equipment, such as robotic arm(s), optical sensors or cameras, AGV(s), motors, consolidation area transfer mechanisms, conveyors, other equipment, sensors (e.g., optical sensors, scanners, etc.) human interface system(s), and other devices. In some implementations, the components may communicate with each other directly, for instance, via a network or communication bus. In some implementations, a central control system, such as a warehouse management system (WMS) or other system may receive signals, perform computations, and issue commands to other devices.

Features of the technology described herein can be integrated into any logistics system, dispatch system, warehouse execution system, warehouse management system, a robot execution server, etc., to coordinate the operations of various systems, information, and devices in a fulfillment system. The technology described herein may provide a fully or partially automated system that provides redundancy, reduces the number of operations, and provides many other benefits described herein. The technology beneficially improves productivity and throughput, increases asset utilization, and lowers cycle time and labor costs. These benefits, in turn, lead to shorter delivery times and result in significant time and resource savings along with reduced error rates.

With reference to the figures, reference numbers may be used to refer to components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

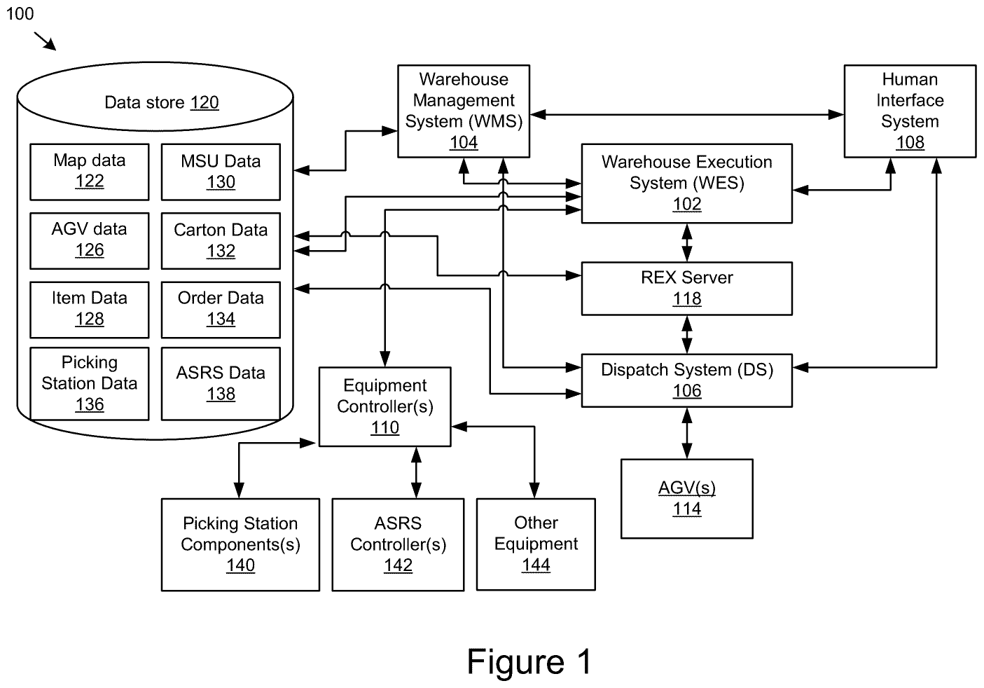

FIG. 1 depicts an example system 100 and data communication flow for implementing an automated robotic fulfillment system, which may use the buffer system described in further detail herein. The system 100 includes a warehouse execution system (WES) 102. The WES 102 is coupled to equipment controller(s) 110, a warehouse management system (WMS) 104, a data store 120 storing various data, a human interface system 108 (e.g., pick-to-voice, pick-to-light, graphical user interface(s), etc.), a robot execution server (REX) 118, a dispatch system 106, and other systems. For instance, the system 100 may include picking station component(s) 140 or other systems, ASRS controller(s) 142, and/or other equipment 144, such as optical sensors or cameras, conveyors, printers, conveyors, robots, or other devices.

The WES 102 may, in some implementations, include one or more hardware and/or virtual servers programmed to perform operations, acts, and/or functionality described herein. For instance, the components of the WES 102 may comprise software routines storable in one or more non-transitory memory devices and executable by one or more computer processors of the WES 102 to carry out operations, acts, and/or functionality described herein. In further implementations, these routines, or a portion thereof, may be embodied in electrical hardware that is operable to carry out the operations, acts, and/or functionality described herein.

For example, the WES 102 may be communicatively coupled with scanner(s), carton conveyor(s) 228, item conveyor(s), diverter(s), picking station component(s) 140, camera(s), robotic arms, and other equipment 144 either directly or via the equipment controller(s) 110, which may be programmable logic controllers (e.g., conveyor controllers, conveyor scanner controllers, automated induction equipment controllers, other warehouse equipment controllers, or other computing devices for controlling equipment).

In some implementations, the WES 102 may receive, process, and transmit data to control software and hardware interactions, for example, by consolidating and controlling information across systems, as described herein. For instance, the WES 102 may serve as a decision point or control software that processes data streams for receiving data, processing the data, instructing devices, and other computations, as noted herein. For example, the WES 102 may communicate with equipment controller(s) 110 and/or other systems to perform operations respective to the buffer system/ASRS. One or more of these operations may be performed via communication with various equipment of the system 100, as described in further detail herein. Accordingly, the WES 102 may provide unified communication that coordinates various systems.

The WES 102 and/or WMS 104 (together or separately) may communicate with various other systems and devices to perform its operations, as described herein, such as equipment controller(s) 110 and equipment. The WES 102 or WMS 104 may communicate with equipment or a human-interface system 108, which may provide instructions for picking items or correcting errors, for instance.

The other equipment 144 may include an item handling station (e.g., where items are placed on a conveyor belt), other box erectors, label applicators, scanners, picking equipment, or other devices for inducting or moving items, mobile storage units, cartons, or other objects in the system; scanners that may include optical, radio, or other scanners or sensors that scan items, containers, totes, mobile storage units, or cartons to identify them; conveyors that may include one or more conveyor belts or other devices that convey objects (e.g., items, mobile storage units, cartons, or other objects), for instance, as described herein Other equipment 144 may include various other devices, such as label applicators, carton-closing equipment, control systems, printers, actuators, motors; or various other devices.

The REX server 118 may, in some implementations, include one or more hardware and/or virtual servers programmed to perform operations, acts, and/or functionality described herein. The REX server 118 may generate a schedule that defines the route for an AGV 114. For a given AGV 114, the REX server 118 may generate an AGV 114 schedule and transmit it to the dispatch system 106, which in turn deploys an AGV 114 according to the schedule or instruction, for instance. In some implementations, the dispatch system 106 instructs the AGV 114 to proceed through one or more areas of the distribution facility according to the schedule/instruction. The schedule of each of the AGVs 114 may be coordinated such that an optimal flow can be achieved. For example, as described elsewhere herein, the REX server 118 may instruct an AGV 114 to retrieve a defined mobile storage unit or tote from a storage area and transport it to a station, buffer shelf 202, storage shelf, or other location in an operating environment.

In some implementations, the REX server 118 may include or may communicate with a routing engine, which may route AGVs 114 and/or objects (e.g., items, mobile storage units, etc.) in a fulfillment center.

In some implementations, the REX server 118 may be used to communicate with ASRS controller(s) 142 or other components.

The dispatch system 106 may be electronically communicatively coupled to a plurality of automated guided vehicles (AGVs) 114. In some implementations, the dispatch system 106, or elements thereof, may be integrated with or communicatively coupled with the REX server 118. The dispatch system 106 includes hardware and software configured to dispatch the AGVs 114 and is coupled for communication the components of the system 100 to receive instructions and provide data. The dispatch system 106 may calculate a route to execute the task considering traffic and resources. In some cases, it adjusts the route or the task in order to make the route efficient.

The AGVs 114 may be robotic vehicles including drive units providing motive force for moving the AGVs 114 (and, in some instances, items, storage units, etc.), guidance systems for determining position of the AGVs 114 within the distribution facility, and equipment for carrying items. Some AGVs 114 may be attached to, include, or carry carts, which, in turn, carry items or storage units. Various configurations of AGVs 114 may be used, such as those with forklifts, robotic arms, or other configurations. In some implementations, in addition to or in lieu of AGVs 114, conveyors or other conveyance mechanisms may be used to transport mobile storage units (e.g., pallets, totes, etc.) or other objects.

The WMS 104 may, in some implementations, include one or more hardware and/or virtual servers or software routines storable in one or more non-transitory memory devices and executable by one or more processors to perform operations, acts, and/or functionality described herein. The WMS 104 may be configured to store and maintain data in the data store 120. In some implementations, the WMS 104 may be configured to communicate with the WES 102, the human interface system 108, dispatch system 106, and/or other systems in real time, in batches, as requested by these components, etc. For example, the WMS 104 may receive data from an e-commerce or other server, process the data, and update various data in the data store 120 based on the order data. Similarly, the WMS 104 may detect and update inventory and other data.

It should be noted that operations described herein in reference to the WMS 104 may be performed by other devices or by other components of the system 100. Similarly, it should be noted that the operations described in reference the WMS 104 and the other components of the system 100 may be distributed or shifted among the components of the system without departing from the scope of this disclosure. For instance, some operations described in reference to the WES 102 or WMS 104 may be performed by the equipment controller(s) 110 or REX server 118, or some operations described in reference to the equipment controller(s) 110, REX server 118, or picking station component(s) 140 may be performed by the WMS 104 or WES 102.

The human interface system 108 may, in some implementations, include one or more hardware and/or virtual servers or software routines storable in one or more non-transitory memory devices and executable by one or more processors to perform operations, acts, and/or functionality described herein. The human interface system 108 may provide instructions and/or receive data (e.g., scan data, user input, confirmations), for example, from human agents or operators (e.g., using barcode scanners, NFC, RFID or radio-frequency identification chips, or other sensors or input methods), as described in further detail below. An example human interface system 108 may include audio, illumination, or a graphical user interface system that receives inputs and/or provides instructions to human agents. The human interface system 108 may be configured to communicate the data with the WES 102, WMS 104, or other components of the system in real time, in batches, as requested by the components of the system, etc.

The human interface system 108 may receive scan data from a client device based on a user scanning a barcode or other identifier of an item, conveyance device, tote, etc. The human interface system 108 may provide instructions to users indicating to place certain items, totes, containers, mobile storage units, etc., at certain locations, remedy errors or exceptions, or perform other actions. For instance, the human interface system 108 may instruct a user to place an item on a consolidation tray, clear a clog in a chute or transfer area of a picking station, correct an error at the buffer system, or perform other actions.

In some implementations, for example, an equipment controller 110 may detect that an error has occurred at a picking station, such as where an item is stuck in a transfer area or funnel/guide. The equipment controller 110 may communicate with the human interface system 108 directly or via a WES 102 or other component to issue instructions to a human agent to clear the error.

The data store 120 is an information source for storing and providing access to data. The data stored by the data store 120 may be organized and queried using various criteria including any type of data stored by it. The data store 120 may include data tables, databases, or other organized collections of data. An example of the types of data stored by the data store 120 may include, but is not limited to map data 122, pallet data, AGV 114 data 126, item data 128, MSU (mobile storage unit) data, carton data 132, order data 134, picking station data 136, ASRS data 138, or other data. In some instances, the data store 120 may also include system attributes, sensor data, labels, system health, etc.

The data store 120 may be included in the WES 102, WMS 104, equipment controller(s) 110, REX server 118, or in another computing system and/or storage system distinct from but coupled to or accessible by the WES 102, WMS 104, REX server 118, equipment controller(s) 110, or other components of the system 100. The WES 102, WMS 104, human interface system 108, REX server 118, and/or dispatch system 106, for example, may store and maintain data in the data store 120. The data store 120 can include one or more non-transitory computer-readable mediums for storing the data. In some implementations, the data store 120 may store data associated with a database management system (DBMS) operable on a computing system. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The map data 122 may include data reflecting the 2- or 3-dimensional layout of the facility including example locations of storage units, automated picking station(s) 140, carton receiving areas/spaces, mobile storage unit receiving area/spaces, conveyors, equipment, storage shelving units, buffer shelves, items, AGVs 114, conveyors, etc. Map data 122 may indicate the attributes of the distribution facility, including attributes of zones/areas of a warehouse. For example, attributes of zones may include the number, quantity, and location of shelving units or bays, storage units, items, boxes/cartons, guidance system locators or markers, etc.

The AGV 114 data 126 may describe the state of an AGV 114, such as operational state, health, location, battery life, storage capacity, objects (e.g., items, mobile storage units, totes, pallets, etc.) being carried, cartons, whether a picker is assigned to it, etc.

The item data 128 may describe items in a distribution facility. The item data 128 may include unique identifiers for these items, the item volume (e.g., the total amount picked in given window (e.g., in an hour, day, etc.)), the item velocity (e.g., number of different times item picked in given window (e.g., per hour, day etc.), the location of the items within the distribution facility (aisle, shelf, shelf position, mobile storage unit, mobile storage unit partition, tote, conveyance device, pallet, etc.), other attributes of the item (e.g., size, description, weight, quantity of items in a package, color, quantity of packages in a container, etc.), item inventory, or mapping of items to storage units, orders, conveyor locations, picking station(s) 140, trays in a picking station, pallets, totes, etc. In some implementations, the item data 128 may include the quantity of particular items a storage unit contains, the current location of a storage unit, a storage location of items and/or storage units, and other data. For instance, the item data 128 may include visual aspects, labels, QR codes, identifying markers, etc., that may be used by the WES 102, WMS 104, or equipment controller(s) 110, etc., to identify items, for example, based on a scan of an item.

The MSU data 130 may include information about mobile storage units (e.g., totes or other containers) in the system, such as a unique identifier or license plate number for each mobile storage unit or container, a mobile storage unit or container type, the zones a mobile storage unit will visit, the current or assigned location of a mobile storage unit, and the priority for the mobile storage unit. The MSU data 130 may include a list indicating the items, item types, and/or the quantity of items a mobile storage unit (or a partition thereof) contains or should contain (e.g., it's maximum or assigned capacity).

The carton data 132 may include various attributes describing box formers 236, available box sizes, box sizes associated with a box former 236, box size(s) associated with an order, the state of each box former 236, box former 236 queues, or other data described herein. For example, the carton data 132 may include license plate numbers or other identifiers on cartons, status and locations of cartons in the systems (e.g., on conveyors), orders or items assigned to cartons, and other data.

Order data 134 may include data pertaining to orders to-be-fulfilled, being fulfilled, and/or already fulfilled in the fulfillment center. For example, the order data 134 may include tables or other files indicating which items are associated with orders, attributes of the items, attributes of the orders, shipping information, box size needed for the items, picking stations to which orders are assigned, status information, or other information for orders.

Picking station data 136 may include various data describing a picking station, such as its location, status, orders assigned to the station, mobile storage unit assigned to or at the station, cartons assigned to or at the station, or other data. For example, as described below, orders and associated items may be assigned to be picked at a station. Orders and/or items may be assigned to and then tagged as pick are completed into defined consolidation trays of the picking station, which may track completion of orders, picking of items, position of trays/a carousel, operations of a human, diverter, or robotic arm, or other information, such as that described herein.

ASRS data 138 may include data describing the locations, storage state, items, or other attributes of buffer shelves. The ASRS data 138 may additionally or alternatively describe the current state, health, pending task, or other attributes of an ASRS robot 204, its components, or its sensors, for example.

The components of the system 100 may be coupled to exchange data via wireless and/or wired data connections. The connections may be made via direct data connections and/or a computer network. The computer network may comprise any number of networks and/or types of networks, such as wide area networks, local area networks, virtual private networks, cellular networks, close or micro proximity networks (e.g., Bluetooth, NFC, etc.), etc. In some implementations, one or more of these components may be coupled via a data communications bus.

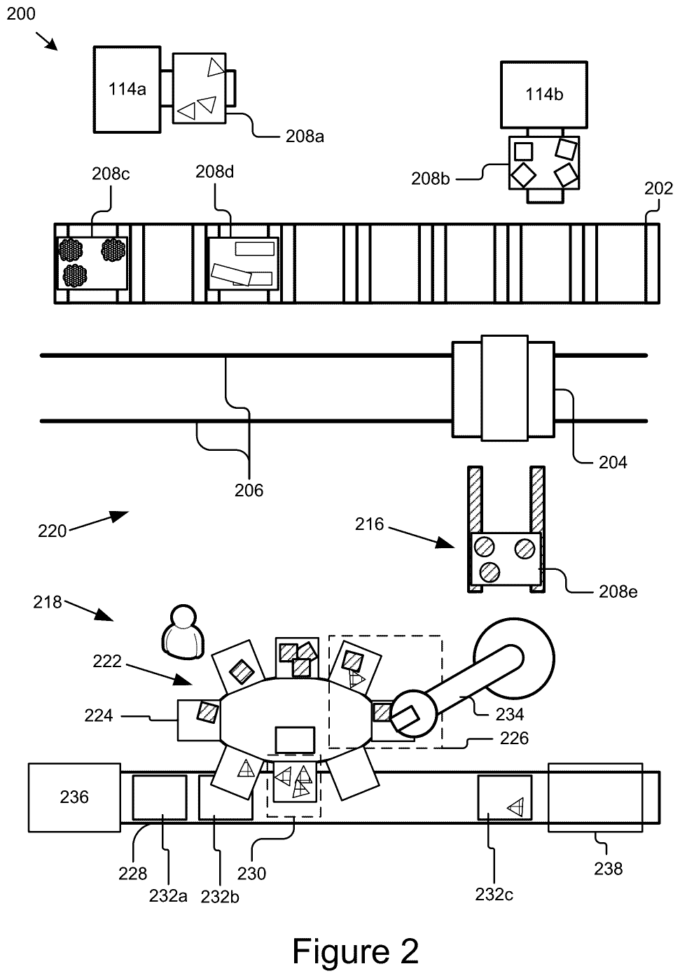

FIG. 2 illustrates an example layout 200 of a portion of a fulfillment center that may be used in the automated robotic fulfillment system. For instance, the layout 200 illustrates a top-down view of an example picking station 218 and adjacent ASRS buffer system 220. It should be noted that the layout 200 is provided as an illustrative example of the technology described herein and that other layouts, configurations, and uses may be used. Additionally, the other figures herein illustrate example configurations and implementations of this technology. While certain examples are described, the operations, components, and features described herein may be modified, interchanged, omitted, or augmented without departing from the scope of this disclosure. It should be noted that while certain movements, interactions, paths, locations, and devices are illustrated, other implementations are possible and contemplated herein.

It should be understood that various facilities may include different configurations. For instance, a fulfillment center, distribution facility, or another location may use some or all of the aspects of the example layout 200. It should be noted that other configurations, components, or layouts are possible and contemplated herein, and the examples are provided by way of illustration.

The example layout 200 illustrates an example picking station 218 with a carousel 222 that includes a plurality of consolidation stations 224, which may also be referred to as areas or trays herein, although various shapes and configurations are possible and contemplated. For example, consolidation stations 224 may be located along a belt, chain, track, or other structure that allows the consolidation stations 224 to move or otherwise be accessible to one or more of a picking location 226, transfer location 230, robotic arm, or other component. In some implementations, the carousel 222 may be a loop, such as a circle, oval, rectangle, or other shape that allows continuous movement of the consolidation stations 224 in the loop. In some implementations, the carousel 222 may include a linear or other arrangement.

Depending on the implementation, a picking station 218 may use a robotic arm 234, diverter, or other mechanism to pick items from mobile storage units 208 (e.g., totes, mobile shelves, pallets, mini pallets, etc.) or directly from a staging area, such as on a conveyor or table. For example, an ASRS robot 204 may place an item (individually or in a mobile storage unit 208, etc.) at the staging area 216 and the robotic arm 234 may pick the item into a tray 224 or shipping carton 232. For instance, the tray 224 may then drop or be dumped into a shipping carton 232, which may be conveyed away from the picking station 218 by a conveyor 228.

It should be noted that other implementations of picking stations 218 are possible and contemplated herein, such as various configurations of the picking station 218, a diverter-based system, a human picking station, or otherwise. The picking stations 218 described herein, for instance, are provided by way of example and the features of the ASRS buffer system 220 described herein may be used in any picking station 218 to improve the flow of objects between storage and picking, as described in the examples herein.

For example, items may be removed from mobile storage units 208 at a picking station 218 and placed into secondary mobile storage units 208 or into shipping cartons 232. A picking station 218 may include multiple staging areas 216 or shelves that hold mobile storage units 208 from which items may be picked by a human, robot, robotic arm, etc.

Depending on the implementation, humans, AGVs 114, diverters, other conveyors, or other devices may be used to move mobile storage units 208 or items between the ASRS 220 and a staging area 216 for a picking station 218. For example, as described below, the ASRS robot 204 may place the mobile storage unit 208 directly onto a conveyor, which may move the mobile storage unit 208 closer to the picking station from the ASRS robot 204. In some implementations, a staging area 216 may include a conveyor. In other implementations, the ASRS robot 204 may place the mobile storage unit 208 or item directly at the staging area 216, for example, on a table or shelf (e.g., which may have access from below similar to a buffer shelf 202). For example, a REX 118 may instruct the ASRS robot 204 to place an item at a defined location, such as at a staging area 218 or conveyor induction location. The system 218 or 220 may include one or more sensors (e.g., optical scanners) that identify and/or confirm identification or locations of mobile storage units 208 or items at the staging area 216.

As illustrated in the example of FIG. 2, the ASRS robot 204 may place a mobile storage unit 208 at a staging area 216, which may include a conveyor. In some instances, a pair of conveyor belts with a space between them to allow a handling mechanism of the ASRS robot 204 to pass between may be used. Accordingly, the ASRS robot 204's handling mechanism may lift or lower a storage unit 208 or item from underneath while also placing it on a conveyor and/or shelf, although other handling mechanisms and mechanisms are possible and contemplated herein. In implementations where the ASRS robot 204 places the storage unit 208/object on the pair of conveyor units, they (and/or another conveyor coupled therewith) may then convey it to or past a picking station 218 where it may be picked to complete a pick task and fulfill an order.

In some implementations, a second conveyor (also referred to as a carton conveyor 228) may be used to transport cartons to and/or past the picking station. In other implementation, other mechanisms, such as AGVs 114, humans, diverters, other conveyors, etc., may bring one or more cartons 232 to the picking station 218, such as to the transfer location(s) 230.

As illustrated in the example layout 200, a plurality of mobile storage units 208 may be transported to, and stored at, the buffer shelves 202 adjacent to one or more picking stations 218 by one or a plurality of AGVs 114 in sequence or parallel. Similarly, once the mobile storage units 208 are no longer needed, the AGV(s) 114 may remove them, transport them to other buffer shelves 202, or return them to storage. The buffer shelves 202 provide storage nearer to picking stations 218 that is more rapidly accessible than would be possible to store the number of storage units 208 needed at a typical fulfillment center due to the large number of items in storage at the fulfillment center, which may hold thousands or even millions of items. As illustrated and described below, in some implementations, each of the shelves 202 may be configured to interact with both AGVs 114 and ASRS robots 204, for example, where AGVs 114 may access the shelves 202 from a first side and ASRS robots 204 may access the shelves from a second, opposing, side.

The ASRS 220 may include an ASRS robot 204 that moves along and/or accesses the buffer shelves 202 to remove objects (e.g., mobile storage units 208) therefrom, move the objects to staging area(s) 216 of picking station(s) 218 or replenishment station(s) (e.g., where items are placed into the mobile storage unit 208 to replenish it), and move objects back to the buffer shelves 202. For example, instead of or in addition to picking, the ASRS system 220 may be used for replenishment to add items to mobile storage units 208.

In some implementations, the ASRS robot 204 may be configured to move along one or more rails 206 in order to access various buffer shelves 202, although other implementations are possible. The rails 206 may provide support, electricity, navigation, and/or other functionality to the ASRS robot 204. The rails 206 may allow the ASRS robot 204 to move much more quickly and stably than a freely-moving AGV 114, thereby increasing speed while also reducing complexity of the ASRS robot 204, such as where less support or components, such as a battery, are needed.

In some implementations, the buffer shelves 202 may be horizontally and/or vertically oriented. For instance, the ASRS robot 204 may move horizontally and/or vertically to access additional buffer shelves 202, as illustrated elsewhere herein.

Once all indicated (e.g., in an order or multiple orders being picked on into trays 224 on a carousel 222) items are picked from a mobile storage unit 208, the REX 118 or WES 102 (or other decision, such as a programmable logic controller, computing device, server, etc.) may instruct the ASRS robot 204 to remove the mobile storage unit 208 (and, in some instances, may first move a conveyor on which the storage unit 208 rests at a staging area 216) and place it at the buffer shelf 202. If the mobile storage unit 208 is not needed at a picking station 218 served by the ASRS robot 204 for a defined time period, or if a space at the buffer shelves 202 is needed, the REX 118 may instruct an AGV 114 to remove the mobile storage unit 208 from buffer shelf 202 and move it to storage or another location (e.g., another set of buffer shelves 202, another picking station 218, a replenishment station, etc.) in a fulfillment center.

Additionally, an ASRS robot 204 may move a next mobile storage unit 208 containing a next SKU/set of items to the picking station 218, and the picking process for the next mobile storage unit 218 may be repeated.

As described below, a computer algorithm may be used to assign order(s) and item(s) to a picking station 218 and buffer shelves 202, generate instructions to move mobile storage unit(s) 218 containing item(s), assign consolidation stations/trays 224 may to an order or part of an order (e.g., where multiple trays 224 are used for a single order or carton 232), update task lists and/or files tracking items in each consolidation stations 224 to track item locations, pick line completion, etc., and perform other operations.

As illustrated in the example layout 200 of FIG. 2, a first AGV 114a may transport a first mobile storage unit/tote 208a holding items in preparation for a current or upcoming order, as described elsewhere herein, to a buffer shelf 202 adjacent to a picking station 218 to which an order containing an item held by the tote 208a is assigned. In other instances, the AGV 114a may retrieve the tote 208a and move it to another buffer shelf 202, picking station 218, or return it to high density or long-term storage in a fulfillment center. Similarly, a second AGV 114b is illustrated holding a second tote 208b is shown aligning the tote 208b with a shelf on the buffer shelves 202. The AGV 114b may also adjust the height of the tote 208b to the designated shelf, move itself, a handling mechanism, and/or the tote 208b to the shelf, and place it thereon. In some instances, the tote 208b may be lowered from underneath onto a shelf having an opening from below to allow access by the handling mechanism, although many other implementations are possible. The WMS 104 may, for instance, update a file (e.g., in the MSU data 130, AGV data 126, order data 134, picking station data 136, ASRS data 138, etc.) to indicate that the shelf is holding the defined tote 208b.

As illustrated in the example of FIG. 2, AGVs 114a and 114b may be on a first side of buffer shelves 202, which may include a plurality of bays or shelves for holding a plurality of items. In some instances, other devices, such as forklifts, humans, robots, conveyor belts, or otherwise may bring totes 208 to the buffer shelves 202. In some implementations, an ASRS robot 204 may also access the buffer shelves 202, potentially on a second, opposing side, as illustrated in FIG. 2 (although the ASRS robot 204 may access the shelves from above, a side, or the same side as the AGVs 114). For example, totes 208c and 208d are illustrated stored on the buffer shelves 202 in a position where they may be accessed from an AGV 114, an ASRS robot 204, or both.

In the depicted example, an ASRS robot 204 may travel along rails 206 to quickly retrieve totes 208 as they are needed in sequence by a picking station 218. For example, an ASRS robot 204 may travel to a designated bay/shelf of the buffer shelves 202, articulate its handling mechanism to retrieve the tote 208, transport the tote 208 to a staging area 216, and place the tote 208 at the staging area 218 using its handling mechanism. For example, the ASRS robot 204 is illustrated having placed a tote 208e on a pair of conveyor belts, which transported the tote 208e a staging area 216 or portion thereof from which items may be picked. In some implementations, multiple staging areas 216 may be used. In some implementations, the ASRS robot 204 may hold the tote 208 (e.g., as in 208e), for example, at a staging area 216 from which items may be picked, such as by a robotic arm 234 (for example, rather than placing it at the staging area 216 or on a conveyor).

In some implementations, multiple ASRS robots 204 may be used for a single set of buffer shelves 202 or for a single picking station 218. In some implementations, an ASRS robot 204 and/or set of buffer shelves 202 may serve multiple staging areas 216 and/or picking stations 218.

In some implementations, a robotic arm 234, human (e.g., using a human interface system 108), humanoid robot, or other device may retrieve a designated item from the tote 208e. The tote 208e may contain a single item, multiple items, and/or multiple SKU types. An optical sensor, such as a scanner or a camera using image recognition, may confirm the quantity or identity of items picked.

In some implementations, the robotic arm 234 (or otherwise) may articulate to a picking location 226 at which it may place the item into a tray 224 (or directly into a carton 232). For example, it may pick multiple items into a single tray for an order having multiple copies of the item. In some instances, the carousel 222 may rotate to place defined trays at the picking location 226. For instance, one or more trays 224 may be assigned to a particular order. The robotic arm 234 may pick items from the tote 208e to multiple trays for the same or different orders.

In some implementations, a box former 236 may form a shipping carton 232 and push it onto a conveyor 228, cart, or other device. For example, shipping cartons 232a, 232b, and 232c are shown on a conveyor 228. A carton 232 may stop under a transfer location 230 at which items are transferred from a tray 224 into a carton 232 (e.g., pushed, dumped, tilted to cause to slide off, etc.). The conveyor 228, cart, or other device may carry the carton downstream for further operations. For instance, it may be transported to or past other devices 238, such as one or more printers (e.g., for placing packing slips), label applicators (e.g., for applying shipping labels), box closers, or other devices.

It should be noted that these configurations, features, and operations are provided by way of illustration and that others are possible and contemplated.

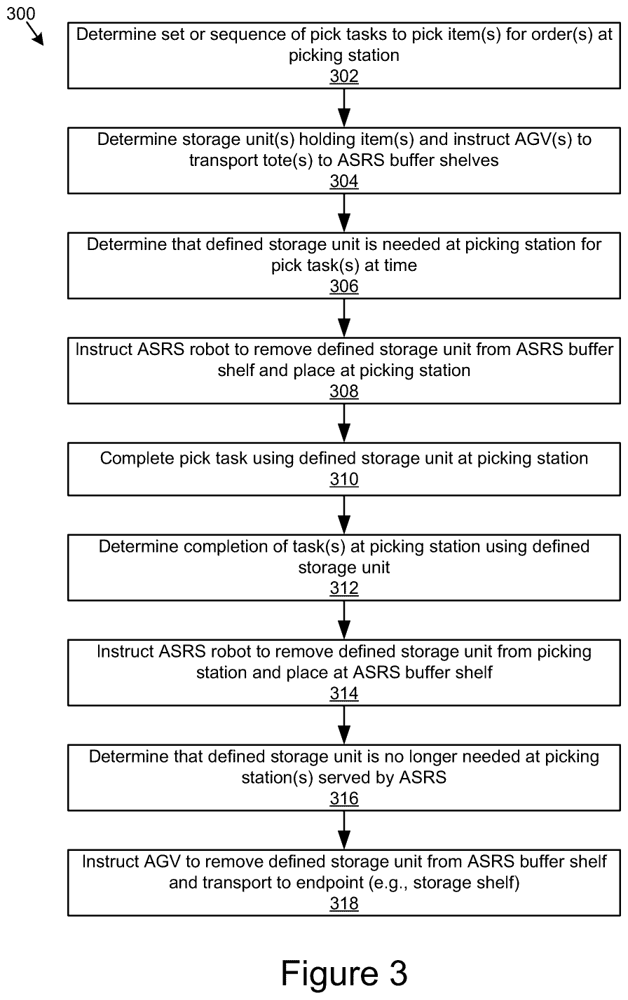

FIG. 3 is a flowchart of an example method 300 for automated robotic picking and buffering using an ASRS buffer system 220 including an ASRS robot 204, such as those described elsewhere herein. The operations described in reference to FIG. 3 may be used with components and features described throughout this description. It should be noted that the operations of the method 300 may be used interchangeably or with the other operations and features used herein. Furthermore, it should be noted that operations of the method 300 and of this description may be augmented, reordered, omitted, or modified while still using technologies described in this disclosure.

It should be noted that, although the operations of the method 300 are described as being performed by the WES 102 (e.g., in conjunction with equipment controller(s) 110), other implementations are possible, such as where a dedicated system, machine, computer, server, process, engine, etc., performs the operations. The WMS 104, WES 102, REX 118, ASRS controller 142, other equipment 144, and/or other decision points or programmable logic controllers, etc., may be communicatively coupled and may also be coupled with various sensors, motors, actuators, and devices, such as those described throughout this disclosure. For instance, an ASRS robot 204, AGVs 114, etc., may be controlled by a WMS 104, human agent, or other device, such as those of the system 100.

Although described in reference to the WMS 104, some operations may be performed directly by the WMS 104, by the equipment controller(s) 110, by other computer decision points/controllers, based on communications between these and other components, or otherwise. For example, it should be noted that some or all of the operations may be performed automatically by an equipment controller 110. In some implementations, operations may be controlled by a human user, such as by applying physical force via levers, by pressing buttons, or otherwise.

The operations and features described in reference to FIG. 3, for example, may be described in additional or alternative detail throughout this disclosure, both in terms of the operations and mechanical components.

At 302, the WMS 104 may determine a set or sequence of pick tasks to pick item(s) for orders at a picking station 218. For instance, the WMS 104 may assign one or more orders, each including one or more items, to a picking station 218. A number of orders may be assigned to be picked in a fulfillment center at a given time, and these orders may each include one or more items that are stored in the fulfillment center.

The WMS 104 may filter and sort the orders/items based on attributes thereof and available picking mechanisms. For example, the WMS 104 may select those orders based on priority, picking station attributes, order fulfillment sequencing, commonality of items between orders, or otherwise. The WMS 104 may group the orders based on similarity of items. For example, if multiple orders contain one or more of the same item, they may be assigned to be picked together at the same buffer shelving unit 202 and/or picking station 218.

In some implementations, orders may be assigned to a picking station 218 as they are received into the fulfillment center and as availability at the picking station 218 becomes open. In some instances, multiple orders may be grouped together based on quantity of common items.

At 304, the WMS 104 may determine one or more storage units 208 holding items/corresponding SKUs and instruct equipment, such as AGVs 114 and/or other devices, to transport the mobile storage units 208 (also referred to herein as totes) to and place them on the ASRS buffer shelf(ves) 202. For example, the WMS 104 may search MSU data 130 to determine one or more mobile storage units 208 having a sufficient quantity of the items for an order or set of orders in a picking period or group. The WMS 104 may communicate with a REX 118 to instruct an AGV 114 or other device to transport the determined mobile storage units 208 to a defined buffer shelf 202. Other methods of bringing the mobile storage units 208 to the buffer shelf 202(es) are also possible.

As noted elsewhere herein, an AGV 114 may navigate using a guidance system, which may include navigation markers or other systems for locating it within a fulfillment center. It may navigate to high-density or longer-term storage and articulate a forklift, suction cup, platform, or other handling mechanism to retrieve one or more totes 208 from a single or multiple storage locations. The WMS 104 may determine an available ASRS buffer shelf 204 at which to place the tote 208, navigate to that location, and articulate its handling mechanism to place the tote 208 at the defined shelf 204.

At 306, the WMS 104 may determine that a defined mobile storage unit 208 is needed at a picking station 218 for a pick task (e.g., at a certain time). For instance, once a previous tote 208 has been completed (e.g., the pick tasks therefrom) at a staging location 216 and a next SKU stored in the next tote 208 is needed, the tote 208 (e.g., at defined buffer shelf 202) may be selected. Accordingly, totes 208 may be shuffled back and forth between a picking station 218 and buffer shelves 202 as they are needed at the picking station 218.

At 308, the WMS 104 may instruct the ASRS robot 204 to remove the defined storage unit 208 from the ASRS buffer shelf 202 and place it at the picking station. For instance, the WMS 104 may instruct an ASRS controller 142 to control the ASRS robot 204. The ASRS controller 142 may move the ASRS robot's handling mechanism horizontally and/or vertically to access a defined buffer shelf 202, extend the handling mechanism to or under the mobile storage unit 208 (or other object), retrieve the storage unit 208, transport the storage unit 208 to a staging location 216 for the picking station 218 (in some implementations, multiple picking stations 218 may use the same ASRS robot 204 and buffer 202), extend the handling mechanism, and deposit the storage unit 202 at the staging area 216.

Where the staging area 216 includes a conveyor, diverter, or similar mechanism, the WMS 104 may also coordinate with associated controllers to move the mobile storage unit 208. For instance, a conveyor may transport the mobile storage unit 208 from an area accessible to the ASRS robot 204 and closer to a robotic arm 234 at the picking station 218.

As noted elsewhere herein, the ASRS robot 204 may travel along the rail 206 and/or articulate its handling mechanism (e.g., raise, lower, extend, retract) to replace and retrieve the mobile storage unit 208. Similarly, as noted elsewhere herein, the ASRS robot 204 may move and articulate to place the mobile storage unit 208 at a staging area 216.

At 310, the WMS 104 may complete the pick task using the defined storage unit 208 at the picking station 218. For instance, the WMS 104 may instruct a robotic arm 234 to move an item from the mobile storage unit 208 and into a shipping carton 232 or consolidation tray 224. For example, the WMS 104 or equipment controller(s) 110 may instruct a robotic arm 234 to grasp an item in the mobile storage unit 208, articulate to a picking location 226 at which the tray 224 is located, and place the item in the tray 224. In other instances, a human interface system 108 may instruct a human picker, by outputting an instruction via a client picking device of the human interface 108, to perform the pick task and receive confirmation thereof. In some instances, multiple items of the same or different types (e.g., SKUs) may be picked from the same storage unit 208.

In some implementations, one or more staging areas 216 at a picking station 218 may receive mobile storage unit(s) 208. A client computing device (e.g., a smart watch, audio speaker, handheld scanner, tablet, etc.) communicatively coupled with the human interface system 108 may output an instruction to a human picker to retrieve a defined item from a defined tote 208, place the item in a defined carton 232, and/or confirm the pick. In other implementations, a robotic arm 234 and/or carousel 222 may be used to pick items from the mobile storage units 208, as noted above.

At 312, the WMS 104 may determine completion of the task(s) at the picking station 218 using the storage unit(s) 208. In some instances, various sensors, cameras, or other equipment may be used to confirm the identity and completion of the pick tasks. The WMS 104 may, accordingly, update a file associated with and order and/or a file associated with the picking station 218, mobile storage unit 208, buffer shelf 202, ASRS robot 204, etc., to indicate completion of the task. For example, the WMS 104 may update a database associated with the order, item, mobile storage unit 208, picking station 218, etc., to reflect that the mobile storage unit 208 is no longer holding the item and this pick task has been completed.

For example, where a picking station 218 includes a carousel 222 with a plurality of trays 224, the WMS 104 may determine that all picks from the particular mobile storage unit 208 are complete for the orders currently assigned to the trays 224, it may instruct the ASRS robot 204 to return the mobile storage unit 208 to a buffer shelf 202. In instances where the mobile storage unit 208 is not needed again (e.g., within a defined time period or number of picks), the WMS 104 may also instruct an AGV 114 to retrieve it from the buffer shelf 204 and move it to a storage shelf.

At 314, the WMS 104 may instruct the ASRS robot 204 to remove the defined storage unit from the picking station and place it at an ASRS buffer shelf 202. For example, this operation may be performed as the reverse of the operations at 308 above, such as where a conveyor is reversed to move the mobile storage unit 208 toward the ASRS robot 204, the ASRS robot 204 articulates its handling mechanism to pick up the mobile storage unit 208, translates along the rail(s) 206 to a designated buffer shelf 202, and articulates its handling mechanism to place the mobile storage unit at the buffer shelf 202.

In some implementations, a picking station 218 may include multiple staging areas 216 that may receive objects, such as mobile storage units 208. For instance, the ASRS robot 204 may first place a next-needed mobile storage unit 208 at a first staging area 216 and then retrieve a previously used/completed mobile storage unit 208 from a second staging area 216. Accordingly, a mobile storage unit 208 may be continuously located and used at the picking station 208 rather than waiting for the ASRS robot 204 to complete tasks.

At 316, the WMS 104 may determine that the defined storage unit 208 is no longer needed at the picking station(s) 218 served by the ASRS robot 204/buffer shelves 202, for example, if no upcoming pick task requires items from the same mobile storage unit 208 at the same or other picking station 218.

At 318, the WMS 104 may instruct an AGV 114 to remove the defined storage unit 208 from the ASRS buffer shelf 202 and transport it to an end point. For example, the WMS 104 may instruct (e.g., via the REX 118) the AGV 114 to navigate to the buffer shelf 202, extend a handling mechanism, retrieve the storage unit, and transport it to the end point. Where the mobile storage unit 208 is needed at another point in the fulfillment center, such as at another picking station 218, at a replenishment station (e.g., to refill the storage unit 208), or otherwise, the AGV 114 may transport it directly to this location. Where the mobile storage unit 208 is not needed or not needed for a defined time period, it may be returned by the AGV 114 to a high-density storage area for storage.

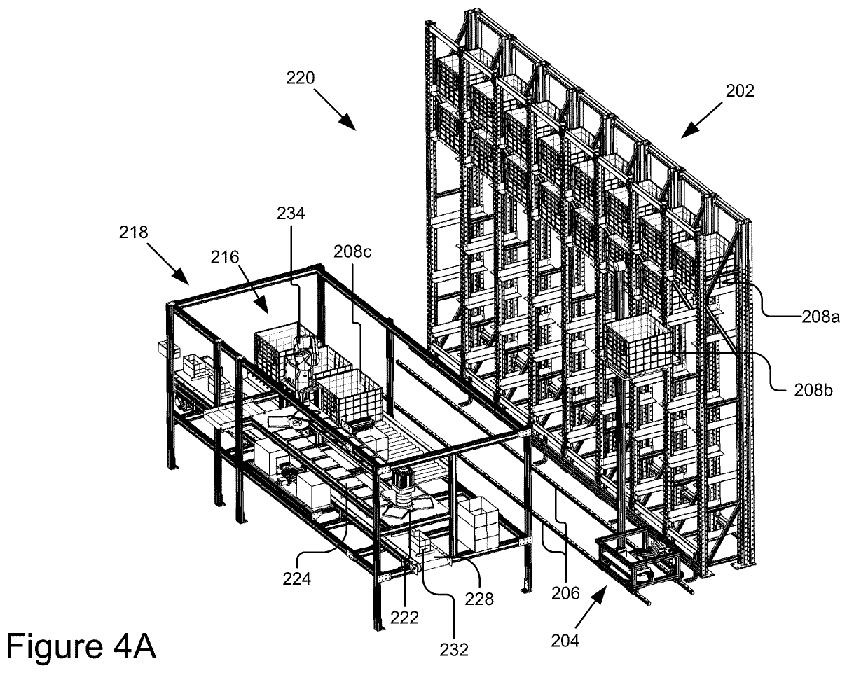

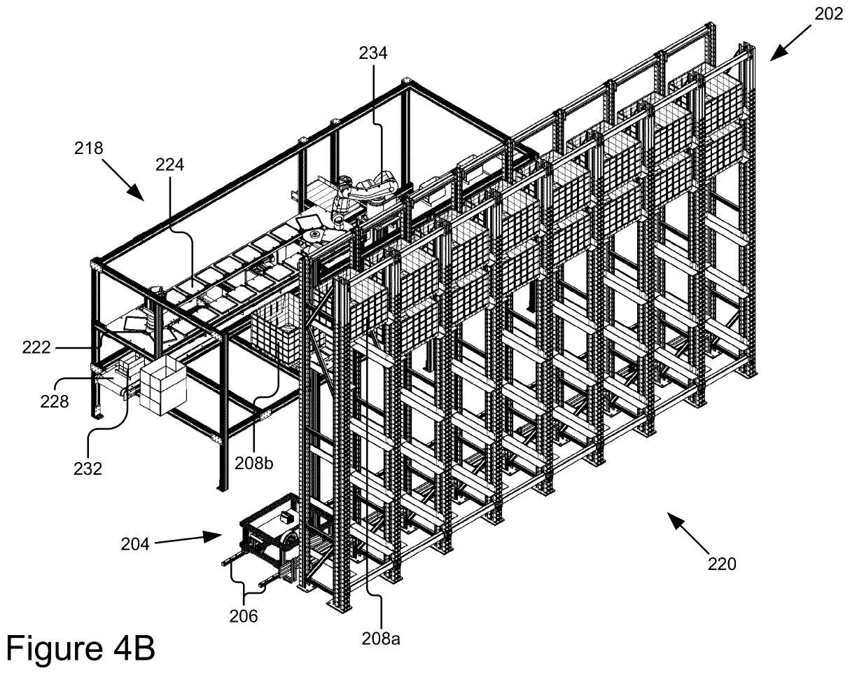

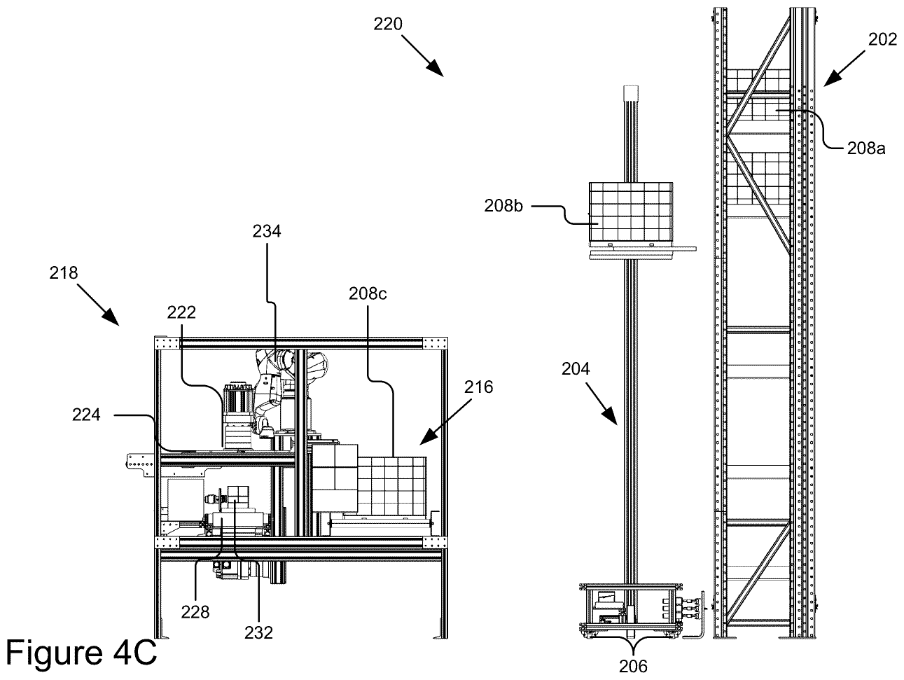

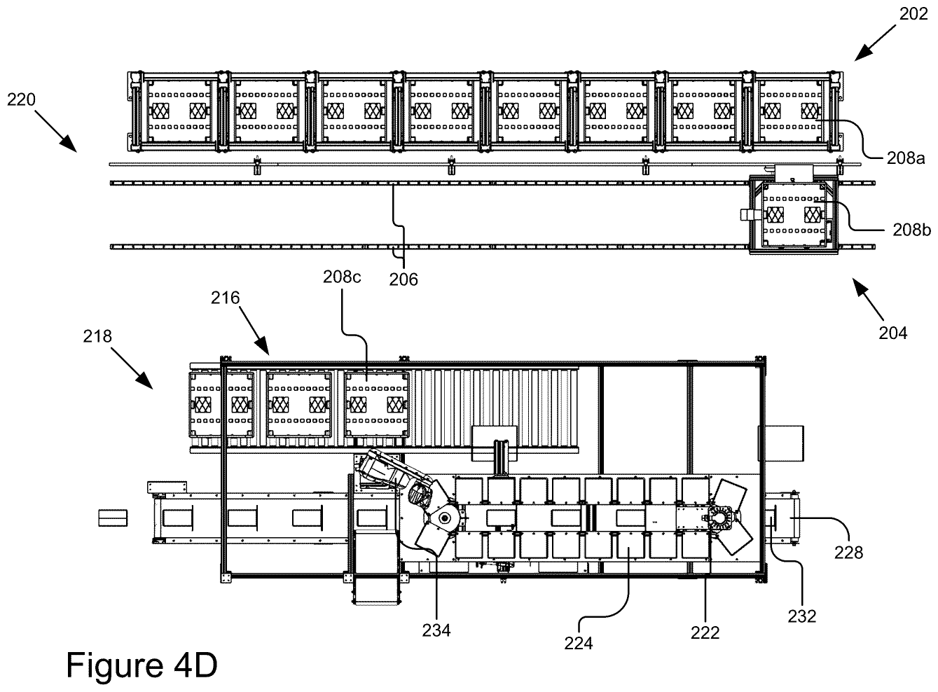

FIGS. 4A-6G illustrate various example implementations of the ASRS 220, which may be used, for example, in conjunction or in alternative with the other features and operations described herein.

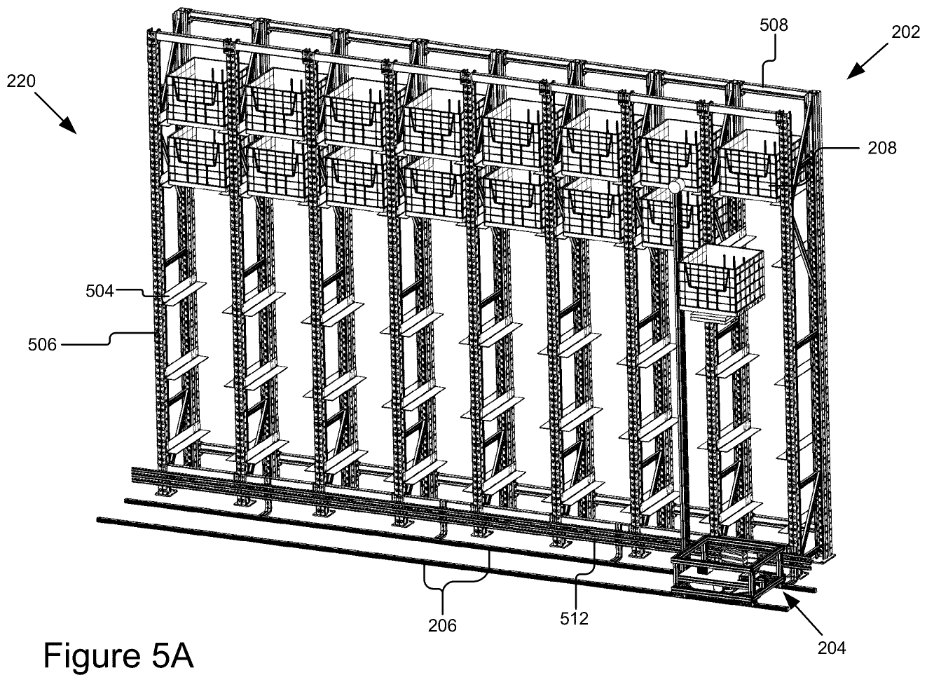

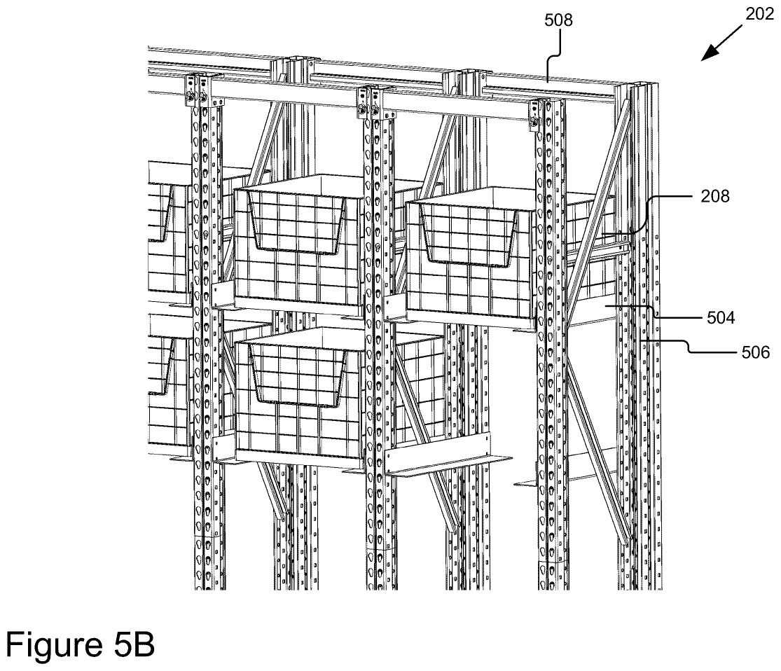

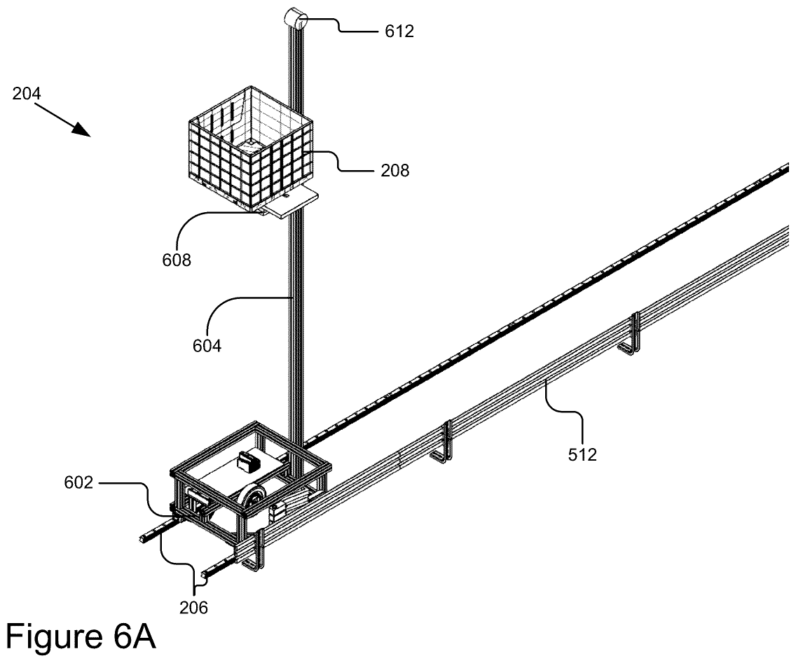

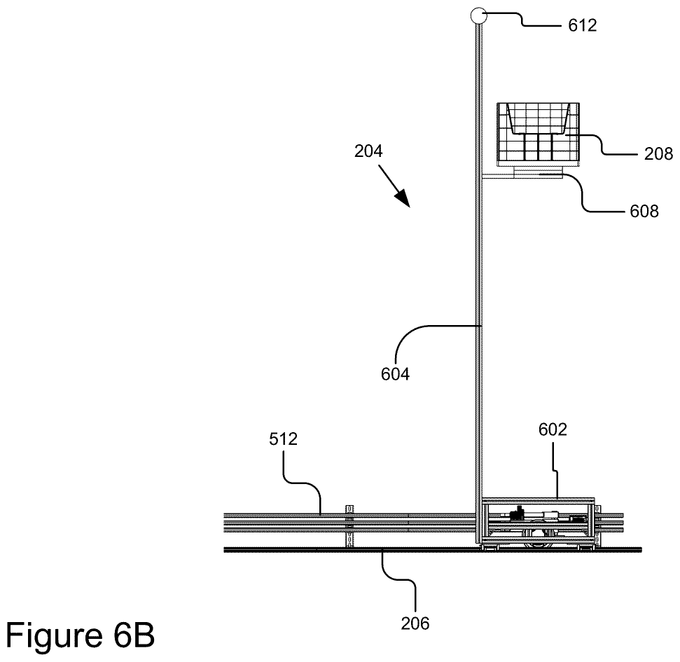

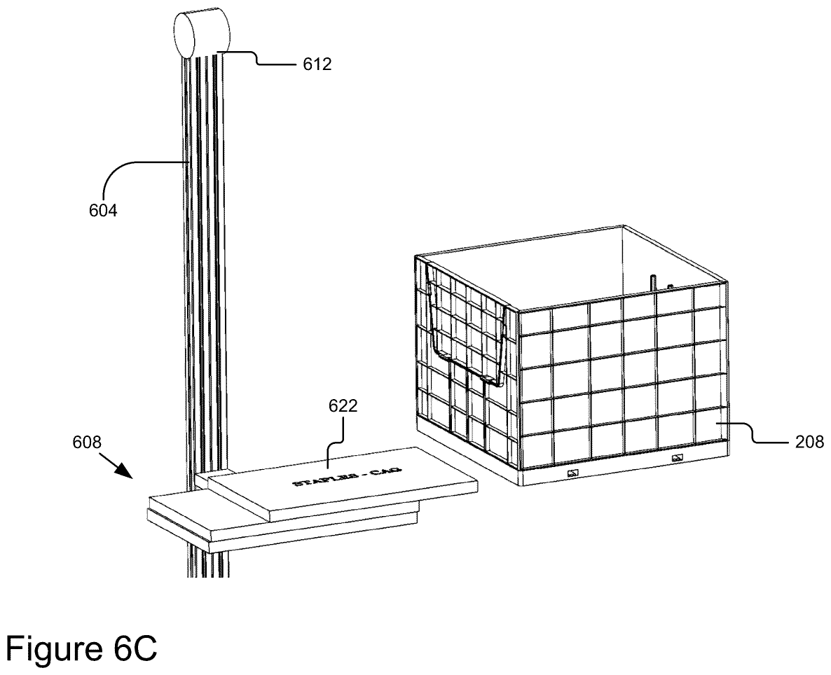

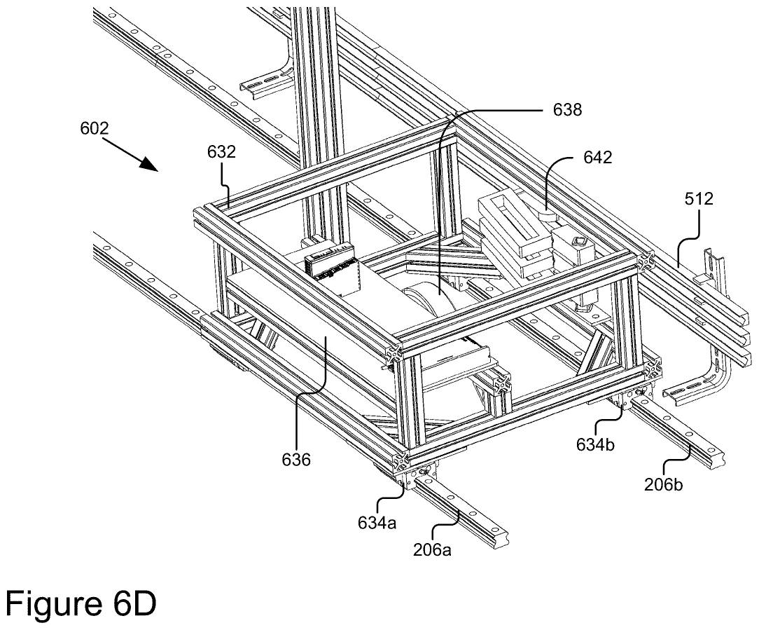

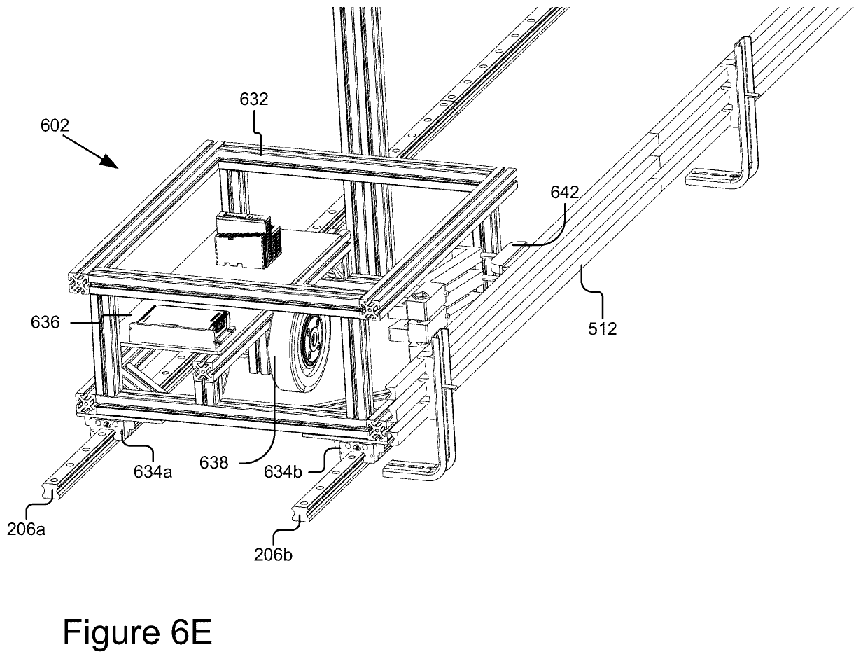

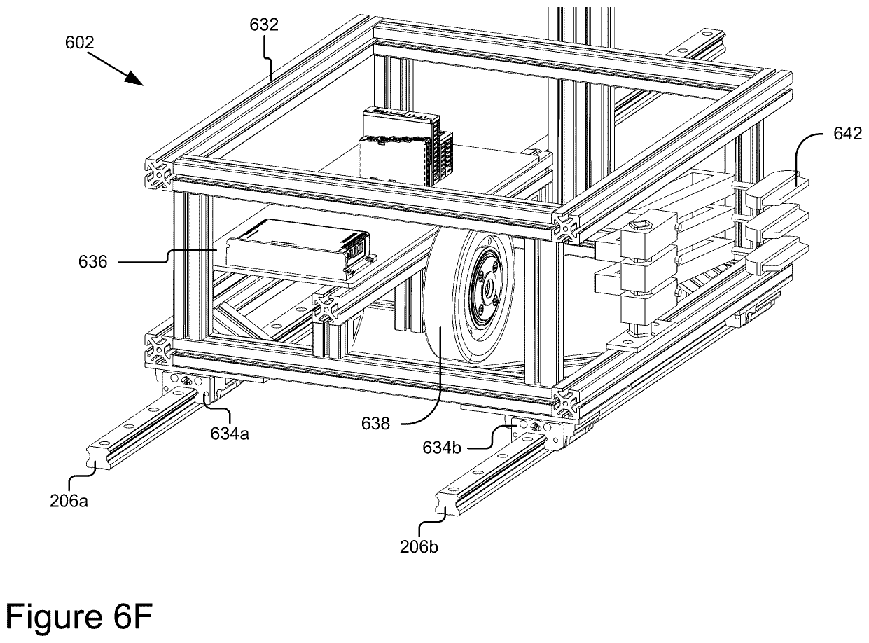

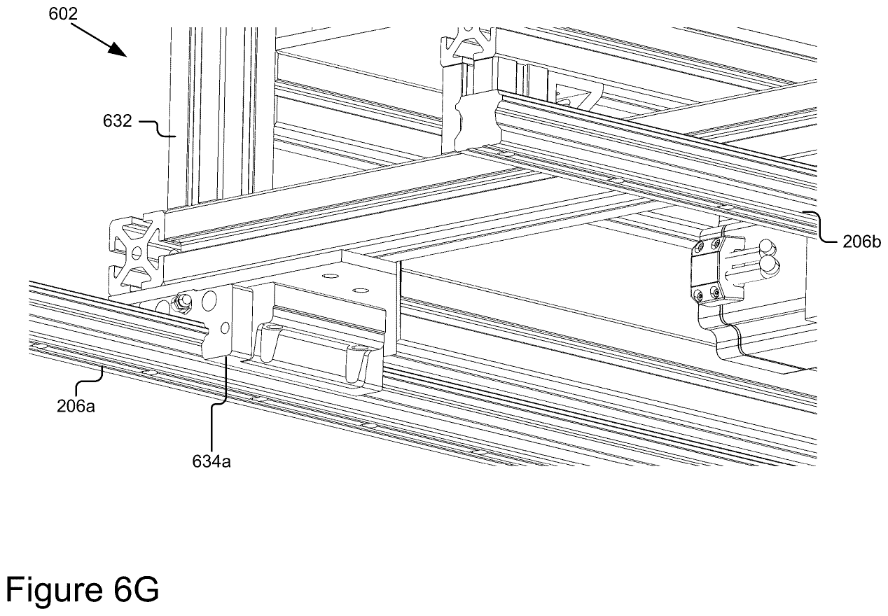

FIGS. 4A-4D illustrate various views of an example picking system in which an ASRS 220 is used, which may be example implementations of the system described in FIG. 2. The example implementations illustrated in these figures include an example picking station 218, ASRS robot 204, and ASRS buffer shelves 202. Example features and details of the ASRS robot 204 and ASRS buffer shelves 202 are described in further detail elsewhere herein, such as below in reference to FIGS. 5A-6G.

FIG. 4A illustrates a front right view, FIG. 4B is a back right view, FIG. 4C is a right-side view, and FIG. 4D is a top-down view of an example ASRS 220 and example picking station 218.

As illustrated in the examples of FIGS. 4A-4D, the ASRS robot 204 may be located in a space between the picking station 218 and the buffer shelves 202, so that it can quickly and directly access both the shelves 202 and picking station 218 to move objects between them. Similarly, the opposing side of the buffer shelves 202 may be open to allow access by other devices, which may place the objects on the shelves 202. For example, because the shelves 202 are configured to allow access from both sides, an ASRS robot 204 may place and retrieve objects from a first side and an AGV 114 may place and retrieve objects from a second side.

Among other benefits, the buffer shelves 202 may be wide enough to allow access by multiple AGVs 114 while the ASRS robot 204 may operate in a limited environment—potentially on a set of one or more rails 206—it may do so more quickly and efficiently to provide items to one or more picking stations 218 (although only a single station 218 is illustrated in the example).

The example picking station 218 illustrated in these figures allows items to be picked from mobile storage units 208 (e.g., 208a, 208b, and 208c labeled in FIGS. 4A-4D) or totes and put into shipping cartons 232. The example carousel 222 picking station 218 includes a plurality of consolidation areas 224, among other features (e.g., multiple conveyors), that may be accessed by a single robotic arm (although other implementations are possible).

The picking station 218 and the buffer 202 may each separately or together be used to buffer spikes in demand and organize tasks in a fulfillment center so that fewer AGVs 114 may be used, for instance.

The example picking station(s) 218 allow multi-line orders, such as orders with multiple picks of a SKU or of multiple SKUs. For example, a carousel picking station may have a plurality of consolidation areas/stations/trays 224 each of which is accessible to a picking mechanism (directly or after rotation of the carousel 222), such as a robotic arm 234, and which may receive a plurality of items and hold them as a buffer until they are complete and/or until a carton 232 (e.g., on a conveyor 228) is ready to receive the items. Accordingly, the picking station 218 may allow multi-line picks to be staged, which provides numerous benefits, as noted in further detail elsewhere herein.

In the depicted example picking station 218, a staging location 216 may include locations for multiple mobile storage units 208 (e.g., 208c), which may be placed on a shelf, table, or conveyor. For example, an ASRS robot 204 may access a single input location for the conveyor, or it may place mobile storage units 208 at multiple locations.

Additional details and features of the ASRS 220 are described in further detail elsewhere herein, such as in reference to FIGS. 5A-6G.

Although other configurations are possible, illustrated example configurations are provided. In some figures, certain elements have been omitted from illustration to improve clarity. The features described in reference to the various figures herein may be omitted, changed, interchanged, or augmented without departing from the technology. For instance, aspects of some example implementations may be used with other implementations.

FIGS. 5A and 5B illustrate example implementations of ASRS buffer shelves 202. FIG. 5A illustrates a front right view of example ASRS buffer shelves/shelving unit 202 with an example ASRS robot 204 in front of it. Example details and features of an ASRS robot 204 are described below. FIG. 5B illustrates a front right view of a portion of an example ASRS buffer shelving unit 202.

In the illustrated example of FIGS. 5A and 5B, the buffer shelves 202 support the sides of mobile storage units 208 and include an opening on one or both sides as well as, potentially, a space underneath for access by an AGV 114 and/or ASRS robot 204. For instance, as illustrated, the supports may include L brackets 504 coupled with vertical posts 506, which form shelves. Beneficially, the illustrated configuration is open at both sides, which allows items to be placed and retrieved from both sides, so that it is bi-directional. The side supports allow a platform or forks of the ASRS robot 204 and/or AGV 114 to extend under the mobile storage unit 208 without contacting the shelf. It should be noted that other shelf configurations and handling mechanisms are possible, for example, rather than extending under and lifting mobile storage units 208, the handling mechanism(s) may have grasping arms, suction cups, or other devices to pull or push the mobile storage units 208 onto/off of the shelves 202.

In some implementations, the vertical posts 506 may be joined at a top and/or bottom by one or more cross braces 508 that provide stability to the buffer shelving unit 202 while allowing accessibility, as noted above.

Although other implementations are possible, the mobile storage unit 208 may be a tote or other container with a bottom and four sides in which items may be stored. A mobile storage unit 208 may include one or more internal dividers, a lid, one or more access doors in the top or side(s), handling mechanism interface mechanisms, or other components. The mobile storage units 208 may have a bar code, QR code, RFID chip, or other ID that allows it to be identified and tracked in a fulfillment center.

As illustrated in FIG. 5A, one or more support rails 206 may be mounted to a floor and may support and/or guide an ASRS robot 204. The rails 206 may couple the ASRS robot 204 to the floor to prevent it from tipping, guide it, locate it, move it, or otherwise, so that it may move more quickly and accurately than would be possible with other systems. Additionally, or alternatively, one or more power and/or other rails 512 may be disposed along the support rails 206 and/or shelves 202. The power rails 512 may, for instance, provide power via brushes, etc., to the ASRS robot 204, as noted in further detail below. The power rail(s) 512 may be integrated or coupled with the rail(s) 206, coupled or integrated with the shelves 202, or may be separate.

FIGS. 6A-6G illustrate various views of the example ASRS 202/ASRS robot 204 and components. FIG. 6A illustrates a back right view and FIG. 6B illustrates a front view of an example ASRS robot 204, example support rails 206, and example power rail(s) 512.

As illustrated in FIGS. 6A and 6B, an ASRS 220 may include support rail(s) 206, power rail(s) 512, an ASRS base 602 coupled with the support rail(s) 206 and receiving power (and/or communication, motive force, etc.) from the power rail(s) 512, an ASRS mast 604 coupled with and extending upward from the ASRS base 602, and a handling mechanism 608 moving along and supported by the ASRS mast 604. It should be noted that although a certain example configurations and components are described and illustrated, others are possible and contemplated.

In the depicted example, an ASRS base 602 may be located near floor level in order to keep much or most of the mass of the ASRS robot 204 low and/or close to the support rail(s) 206, which improves stability and ability to accelerate. The ASRS base 602 is described in further detail below, for example, in reference to FIGS. 6D-6G.

In the depicted example, a mast 604 may extend upward from the ASRS base 602. The mast 604 may include a vertical support, pole, track, or frame, for example, which provides support to a handling mechanism 608 and, in some implementations, allows the handling mechanism 608 to move up down the mast 604. The mast 604 may be telescoping and/or may include a track along which one or more wheels of a handling mechanism 608 may run. In some implementations, the mast may include a wheel, gear, or pulley 612 at or near a top and around which a belt, cable, or chain may rotate. For instance, the handling mechanism 608 may be coupled with a belt, which pulls it up or down along the mast 608. A gear and motor may also be coupled with the belt, etc., and may be located in the ASRS base 602, as described below.

Additional features or details of these components are described elsewhere herein, but it should be noted that these are provided by way of example and other implementations are possible.

As illustrated in FIG. 6C, a handling mechanism 608 may include a platform 622 that slides horizontally in a direction perpendicular to a direction of movement of the ASRS robot 204, for example, to slide toward buffer shelves 202 (not shown in FIG. 6C) and/or a picking station staging area 216 (not shown in FIG. 6C). For example, the handling mechanism 608 may slide the platform 622 along rails using linear actuators, chain drives, or various other mechanisms to allow it to extend under a mobile storage unit 208 in one or more directions, although other implementations are possible and contemplated.

In some implementations, a platform 622 may be coupled with slides, rails, gas rams, tracks, etc., to allow it to slide horizontally. In some implementations, it may slide to either direction from a neutral position next to the mast (e.g., it is shown partially extended to one side in FIG. 6C). This sliding mechanism may be actuated, for example, using a belt or chain and motor/gear assembly, a gas ram, linear actuator, rack and pinion, or various other mechanisms. In some implementations, the platform 622 may slide in multiple stages to allow it to extend farther, as illustrated in FIG. 6C two movable components may slide out to extend the reach of the handling mechanism 608. The bottom-most platform or component may be mounted to the mast 604.

The platform may slide horizontally and may be raised/lowered along the mast 604 (e.g., a chain coupled therewith), which allows it to lift mobile storage unit(s) 208 from shelves, place them on shelves, etc., as noted elsewhere herein.

It should be noted that although a particular example implementation is shown, others are possible, such as where the handling mechanism 608 rotates the platform 622, or where a forklift mechanism, robotic arm, suction cup, crane, or various other mechanisms are used.

The handling mechanism 608 may move vertically along the mast 604. In some implementations, the mast 604 may include a sprocket, pulley 612, or other device at the top that may allow a belt or chain to pass over the top. For instance, one or more belts may extend over the sprocket, and a motor-driven gear may cause the handling mechanism 608 to move upward/downward along the mast 604. Accordingly, an ASRS controller 142 may instruct the mast motor to move the platform 622 to a defined height, the handling mechanism 608 may extend the platform 622 under a mobile storage unit 208 on a shelf, the mast motor may raise the handling mechanism 608 and platform 622 to lift the mobile storage unit 208, and the handling mechanism 608 may retract the platform 622 to retract the mobile storage unit 208. These operations may be reversed to place the mobile storage unit 208 at a shelf. Other implementations and movements are possible and contemplated herein.

FIGS. 6D-6G illustrate various views of an example ASRS base 602. As illustrated, an ASRS base 602 may include a body, which may include a frame structure 632 that provides structure to the ASRS robot 204. FIG. 6D shows a right front view of an example ASRS base 602. FIG. 6E illustrates a right back view of an example ASRS base 602. FIG. 6F illustrates a right back view of an example ASRS base 602 with a power rail 512 omitted from the illustration. FIG. 6G illustrates a bottom right perspective view of a portion of the ASRS base 602 showing an example rail 206 and example interface component 634. It should be noted that front, back, right, left, etc., are used herein only for purposes of describing the figures and that other directions and terms may additionally or alternatively be applicable.

The structure 632 may be constructed of aluminum extrusions, stamped plates, or otherwise. As shown in the example, the base 602 may include or be coupled with support rail bearings and/or interface components 634 (634a and 634b are labeled), which may include wheels or bearings that allow the ASRS base 602 to move along and be coupled with the support rail(s) 206a and 206b. The support rail(s) 206 may be bolted directly to a floor of the fulfillment center. The rail(s) 206 may include locating markers that may be scanned by the ASRS robot 204, although many other types of locating mechanisms are possible. Additional details about the rails 206 and interface components are described below in reference to FIG. 6G.

The ASRS base 602 may include a support surface 636 to which a control unit, power supply, motors, sensors or other components may be mounted. For example, the control unit may communicate with the motors and sensors to move the handling mechanism (not visible), mast motor (not visible), translation motor and wheel 638 (a wheel or gear connected to a floor or rails 206), or otherwise to locate the ASRS robot 204 along the rails 206 and relative to shelves (not visible), etc. The control unit may have processors, a communication unit, and other components, as described elsewhere herein.

The ASRS robot 204 may include a translation motor and wheel 638 that causes the ASRS body 602 to translate horizontally along the rails 206. In some implementations, the translation motor may be located on or in the ASRS base 602. For example, the translation motor may include or be coupled with a wheel 638 that contacts the support rails 206 or floor (e.g., between the rails, as illustrated) and is rotated by the motor to translate the ASRS base 602 along the rails. The ASRS robot 204 may use markers (e.g., read by an optical or other sensor) on the rails 206 or 512, floor, or other mechanisms for locating it.

In some implementations, the ASRS base 602 may include brushes 642 (e.g., spring-loaded brushes) that contact the power rail(s) 512 (which may be combined or separate from the support rails, etc.) and provide power to the ASRS robot 204's components. It should be noted that other means of providing power are possible, such as where the ASRS robot 204 includes a rechargeable battery or where it is continuously coupled with an external power source using wire(s) (e.g., in a wire chase and/or drag chain).

As shown in the example of FIG. 6G, an interface component 634a is shown coupled with a guide/support rail 206a (a second support rail 206b is also visible, though a second interface for the second rail 206b is not visible). The rail(s) 206 may have a profile that allows one or more interface components 634 to extend around the rail(s) 206 to both guide the ASRS robot 204 and, potentially hold it down/keep it stable. In some cases, the interface component(s) 634 may include wheels or ball bearings that ease movement whether or not they support the weight of the ASRS robot 204. As illustrated in the example of FIG. 6G, one or more (e.g., four—one at each corner) interface components 634 may be bolted to the bottom of a structure 632 of the ASRS base 602 to provide support, stability, and/or guidance to it.

It should be noted that although a certain example structure 632, arrangement, and components are shown, these are only provided as examples and the features and techniques shown and described may take various other forms, shapes, or configurations.

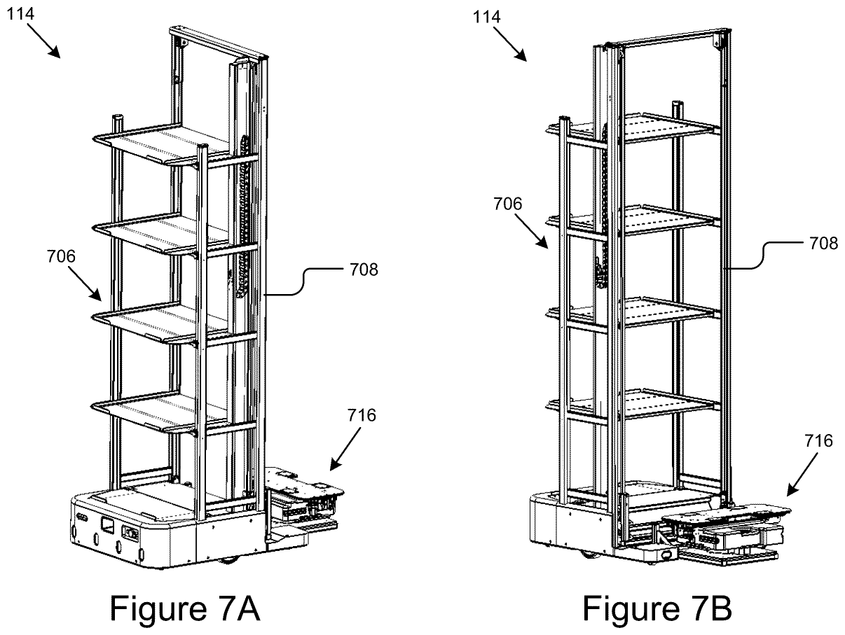

FIGS. 7A and 7B illustrate views of an example AGV 114 that may be used to transport mobile storage units 208 (not shown in FIGS. 7A-7B) or other objects between a high-density storage area and the ASRS buffer shelves 202 (not shown in FIGS. 7A-7B). It should be noted that although a particular example is shown, many other types of AGVs 114 or means of moving objects to the buffer shelves 202 are possible, such as other AGVs 114, humans, humanoid robots, robotic arm robots, robotic forklifts, etc.

The example picking AGVs 114 may reach and retrieve different sizes of mobile storage units 208 (e.g., pallets, totes, cartons, or other items, etc.) from different levels of storage shelves using a container handling mechanism (CHM) 716 and a carrying surface.

FIGS. 7A and 7B depict an example picking AGV 114, which may include an AGV 114 body, a drive unit housed within or coupled to the body, a power source (not shown) housed within or coupled to the body, an AGV 114 item storage rack 706 with one or more shelves, a container handling mechanism (CHM) 716, a carrying surface, a guidance system (not shown), and one or more controllers (not shown), although other configurations are possible and contemplated herein.

While various shapes and construction materials to the body are possible, the body may be configured to fit between rows of storage shelving in a high-density storage area. The body may be configured to house a drive unit (e.g., electric motors and wheels moving the AGV 114), power source (e.g., a battery), controller (e.g., a computing device), and/or other components of the picking AGV 114.

Some implementations of the picking AGV 114 may include an AGV item storage rack 706 coupled with the body and proximate to the CHM 716 so that the shelf(ves) are within reach of the CHM 716 for the CHM 716 to place items on the shelves.

The container handling mechanism or CHM 716 may include an extender for extending a carrying surface from a picking AGV 114 to a storage shelving unit that is separate from the picking AGV 114. The CHM 716 may have three or more degrees of freedom to move the carrying surface along three or more axes thereby allowing the CHM 716 to retrieve an item from a first target shelving unit using the carrying surface and the three or more degrees of freedom and place the item on a second target shelving unit.

In some implementations, the CHM 716 may include a mast having an elevator 708 coupled with the body and/or AGV rack 706. The elevator 708 lifts and lowers a platform supporting a carrying surface. The elevator 708 moves the CHM 716 along a Z axis to lift and set down the carton.

In some implementations, the platform extends or retracts the carrying surface horizontally between the picking AGV 114a and a shelf of a storage location, a buffer shelf 202, or a staging location 216. In some implementations, the platform may also extend or retract the carrying surface into or out of one or more of the AGV 114 shelves to place an item on one of the AGV shelves. The CHM 716 may include a moveable platform having a carrying surface capable of translating along a plane in two or more dimensions and/or rotating about a vertical axis. For example, the platform (or other component of the CHM 716, depending on the implementation) may translate the carrying surface along any X and Y coordinates (e.g., sideways/left and right relative to the front of the picking AGV 114a; forward and backward relative to the front of the picking AGV 114a; etc.). This allows the CHM 716 to retrieve an item from a storage shelf and move it to and place it on an AGV shelf supported by the frame, and vice versa. The CHM 716 may be adjustable to translate between an X axis, Y axis, a combination, etc.

The picking AGV 114 may include a guidance system that determines a location of the picking AGV 114 within the operating environment. For instance, the guidance system may include one or more sensors that detect and process navigation markers (e.g., QR codes, RFID labels, etc.) to locate the picking AGV 114 as the picking AGV 114 traverses the operating environment. The guidance system may be coupled with a controller of the picking AGV 114, which may, in some instances, include local object detection intelligence and processing to avoid collision with other objects (e.g., AGVs 114, humans, items, storage shelving units, etc.) in the operating environment.

The picking AGV 114 may include one or more controllers coupled with the guidance system, CHM 716, drive unit, dispatch system, etc., to perform the operations described herein. The one or more controllers may receive a signal from the REX 118 indicating to retrieve a particular item from a target storage unit, in response to which, the one or more controllers may instruct the drive unit to position the CHM 716 adjacent to the target shelving unit using the current location determined by the guidance system and then direct the CHM 716 to retrieve the item, for example.

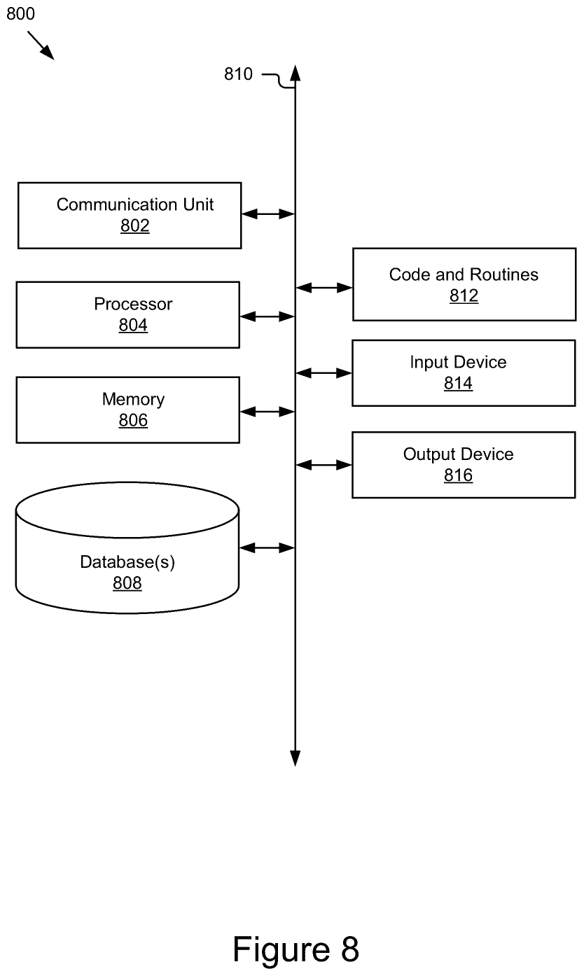

FIG. 8 is a block diagram illustrating an example computing system 800. The example computing system 800 may correspond to a WES 102, a WMS 104, a dispatch system 106, a human interface system 108, equipment controller(s) 110, REX server 118, a client device, picking station component(s) 140, ASRS controller(s) 142, other equipment 144, a computing device of a picking station, a computing device of a robotic arm, a computing device/controller of an AGV 114 or ASRS robot 204, or other component of the system 100, for example.

The code and routines 812 may include computer logic executable by the processor 804 on a computing system 800 to provide for the functionality described in reference to one or more of the components of the system 100. For instance, in some implementations, the code and routines 812 may include one or more of the components of the WMS 104, equipment controller(s) 110, ASRS controller 142, or other system(s) for controlling the ASRS 220 and/or components thereof.

As depicted, the computing system 800 may include a processor 804, a memory 806, a communication unit 802, an output device 816, an input device 814, and database(s) 808, which may be communicatively coupled by a communication bus 810. The computing system 800 depicted in FIG. 8 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 800 may include various operating systems, sensors, additional processors, and other physical configurations. Although, for purposes of clarity, FIG. 8 only shows a single processor 804, memory 806, communication unit 802, etc., it should be understood that the computing system 800 may include a plurality of one or more of these components.

The processor 804 may execute software instructions by performing various input, logical, and/or mathematical operations. The processor 804 may have various computing architectures to process data signals including, for example, a complex instruction set computer (CISC) architecture, a reduced instruction set computer (RISC) architecture, and/or an architecture implementing a combination of instruction sets. The processor 804 may be physical and/or virtual, and it may include a single core or plurality of processing units and/or cores. In some implementations, the processor 804 may be capable of generating and providing electronic display signals to a display device, supporting the display of images, capturing and transmitting images, performing complex tasks including various types of feature extraction and sampling, etc. In some implementations, the processor 804 may be coupled to the memory 806 via the bus 810 to access data and instructions therefrom and store data therein. The bus 810 may couple the processor 804 to the other components of the computing system 800 including, for example, the memory 806, the communication unit 802, the input device 814, the output device 816, and the database(s) 808.

The memory 806 may store and provide access to data to the other components of the computing system 800. The memory 806 may be included in a single computing device or a plurality of computing devices. In some implementations, the memory 806 may store instructions and/or data that may be executed by the processor 804. For example, the memory 806 may store the code and routines 812. The memory 806 is also capable of storing other instructions and data, including, for example, an operating system, hardware drivers, other software applications, databases, etc. The memory 806 may be coupled to the bus 810 for communication with the processor 804 and the other components of computing system 800.

The memory 806 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 804. In some implementations, the memory 806 may include one or more of volatile memory and non-volatile memory (e.g., RAM, ROM, hard disk, optical disk, etc.). It should be understood that the memory 806 may be a single device or may include multiple types of devices and configurations.

The bus 810 can include a communication bus for transferring data between components of a computing device or between computing devices, a network bus system including a network or portions thereof, a processor mesh, a combination thereof, etc. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 802 may include one or more interface devices (I/F) for wired and wireless connectivity among the components of the system 100. For instance, the communication unit 802 may include various types of connectivity and interface options. The communication unit 802 may be coupled to the other components of the computing system 800 via the bus 810. The communication unit 802 may be electronically communicatively coupled to a network (e.g., wiredly, wirelessly, etc.). In some implementations, the communication unit 802 can link the processor 804 to a network, which may in turn be coupled to other processing systems. The communication unit 802 can provide other connections to a network and to other entities of the system 100 using various standard communication protocols.

The input device 814 may include any device for inputting information into the computing system 800. In some implementations, the input device 814 may include one or more peripheral devices. For example, the input device 814 may include a keyboard, a pointing device, microphone, an image/video capture device (e.g., camera), a touchscreen display integrated with the output device 816, optical scanner, barcode reader, QR™ code reader, RFID (radio-frequency identification) tag reader, etc.

The output device 816 may be any device capable of outputting information from the computing system 800. The output device 816 may include one or more of a display (LCD, OLED, etc.), a printer, a 3D printer, a haptic device, audio reproduction device, touch-screen display, etc. In some implementations, the output device is a display which may display electronic images and data output by the computing system 800 for presentation to a user, such as a picker or associate in the order fulfillment center. In some implementations, the computing system 800 may include a graphics adapter (not shown) for rendering and outputting the images and data for presentation on output device 816. The graphics adapter (not shown) may be a separate processing device including a separate processor and memory (not shown) or may be integrated with the processor 804 and memory 806.

The database(s) are information source(s) for storing and providing access to data. The data stored by the database(s) 808 may be organized and queried using various criteria including any type of data stored by them, such as the data in the data store 120 and other data discussed herein. The database(s) 808 may include file systems, data tables, documents, databases, or other organized collections of data. Examples of the types of data stored by the database(s) 808 may include the data described herein, for example, in reference to the data store 120.

The database(s) 808 may be included in the computing system 800 or in another computing system and/or storage system distinct from but coupled to or accessible by the computing system 800. The database(s) 808 can include one or more non-transitory computer-readable mediums for storing the data. In some implementations, the database(s) 808 may be incorporated with the memory 806 or may be distinct therefrom. In some implementations, the database(s) 808 may store data associated with a database management system (DBMS) operable on the computing system 800. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

It should be noted that the components described herein may be further delineated or changed without departing from the techniques described herein. For example, the processes described throughout this disclosure may be performed by fewer, additional, or different components.

It should be understood that the methods described herein are provided by way of example, and that variations and combinations of these methods, as well as other methods, are contemplated. For example, in some implementations, at least a portion of one or more of the methods represent various segments of one or more larger methods and may be concatenated or various steps of these methods may be combined to produce other methods which are encompassed by the present disclosure. Additionally, it should be understood that various operations in the methods are iterative, and thus repeated as many times as necessary generate the results described herein. Further the ordering of the operations in the methods is provided by way of example and it should be understood that various operations may occur earlier and/or later in the method without departing from the scope thereof.

In the above description, for purposes of explanation, numerous specific details are set forth in order to provide a thorough understanding of the present disclosure. However, it should be understood that the technology described herein can be practiced without these specific details in various cases. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening 1/O controllers. The data processing system may include an apparatus that may be specially constructed for the required purposes, or it may comprise a general-purpose computer selectively activated or reconfigured by a computer program stored on the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects may not be mandatory or significant, and the mechanisms that implement the specification or its features may have different names, divisions, and/or formats.

Furthermore, the modules, routines, features, attributes, methodologies, and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A system comprising:
a set of buffer shelves holding one or more mobile storage units, each of the one or more mobile storage units holding at least one item;
a mobile robot including a body structure supporting a handling mechanism and a translation motor, the translation motor moving the body structure to a first buffer shelf of the set of buffer shelves, the handling mechanism moving a first mobile storage unit of the one or more mobile storage units from the first buffer shelf to a staging area; and
a picking station including the staging area at which the first mobile storage unit is held, a picking location at which a carton is held, and a picking mechanism for moving a first item from the first mobile storage unit to the carton.

2. The system of claim 1, wherein:
the set of buffer shelves include a plurality of buffer shelves arranged in a grid of at least two shelves wide by at least two shelves tall.

3. The system of claim 2, wherein:
each of the plurality of buffer shelves is open at two opposing sides, the mobile robot accessing each of the plurality of buffer shelves at a first side of the two opposing sides, an automated guided vehicle accessing each of the plurality of buffer shelves at a second side of the two opposing sides, the automated guided vehicle being adapted to transport the one or more mobile storage units from a storage area to the set of buffer shelves.

4. The system of claim 2, wherein:
each of the plurality of buffer shelves include a vertical post supporting at least two brackets, the at least two brackets supporting the one or more mobile storage units from two sides of the one or more mobile storage units while leaving a space open underneath the one or more mobile storage units and between the at least two brackets.

5. The system of claim 1, further comprising:
a support rail running horizontally along a face of the set of buffer shelves, the mobile robot being coupled with the support rail, the support rail providing guidance to the mobile robot.

6. The system of claim 5, further comprising:
a power rail running along the face of the set of buffer shelves, the power rail providing electrical power to the mobile robot using one or more contact points between the mobile robot and the power rail.

7. The system of claim 5, wherein:
the mobile robot includes a mast extending vertically from the body structure, the mast supporting the handling mechanism, the handling mechanism moving vertically along the mast, the handling mechanism of the mobile robot accessing the first buffer shelf based on a position of the mobile robot horizontally along the support rail and based on a position of the handling mechanism vertically along the mast.

8. The system of claim 7, wherein:
the handling mechanism includes a support platform that translates horizontally away from the mast in a first direction when retrieving the first mobile storage unit from the first buffer shelf and translates horizontally away from the mast in a second direction when placing the first mobile storage unit at the staging area.

9. The system of claim 1, wherein:
the staging area includes a conveyor adapted to move the first mobile storage unit from a first location at which the first mobile storage unit is received from the mobile robot and to move the first mobile storage unit closer to the picking station.

10. The system of claim 1, further comprising:
an automated guided vehicle that moves freely within an operating environment to retrieve the one or more mobile storage units from one or more locations in a storage area, the mobile robot being coupled to a support rail parallel to a face of the set of buffer shelves and moves the one or more mobile storage units between the set of buffer shelves and the staging area.

11. A method comprising:
instructing, by one or more processors, a robot to remove a first mobile storage unit from a set of buffer shelves using a handling mechanism, the first mobile storage unit holding at least one item;
instructing, by the one or more processors, the robot to place the first mobile storage unit at a staging area using the handling mechanism;
instructing, by the one or more processors, a picking mechanism at a picking station to perform a pick task including removing a first item from the first mobile storage unit;
determining, by the one or more processors, that the pick task has been completed at the picking station using the first mobile storage unit;
instructing, by the one or more processors, the robot to remove the first mobile storage unit from the staging area using the handling mechanism; and
instructing, by the one or more processors, the robot to place the first mobile storage unit on the set of buffer shelves.

12. The method of claim 11, further comprising:
instructing, by the one or more processors, one or more automated guided vehicles to transport the first mobile storage unit from a storage area and place the first mobile storage unit on a first buffer shelf of the set of buffer shelves.

13. The method of claim 12, further comprising:
determining, by the one or more processors, that the first mobile storage unit is not needed for a subsequent pick task at the picking station; and
responsive to determining that the first mobile storage unit is not needed, instructing, by the one or more processors, the one or more automated guided vehicles to retrieve the first mobile storage unit from the set of buffer shelves and transport it to the storage area.

14. The method of claim 11, further comprising:
determining, by the one or more processors, a set of pick tasks for items in orders assigned to a picking station;
determining, by the one or more processors, a set of mobile storage units holding the items in the orders, the set of mobile storage units including the first mobile storage unit; and
instructing, by the one or more processors, one or more automated guided vehicles to transport the set of mobile storage units from a storage area to the set of buffer shelves.

15. The method of claim 11, wherein instructing the picking mechanism at the picking station to perform the pick task includes:
instructing a robotic arm to remove the first item from the first mobile storage unit and place it in a carton at a picking location.

16. The method of claim 11, wherein instructing the picking mechanism at the picking station to perform the pick task includes:
instructing a human picker via human interface device to remove the first item from the first mobile storage unit and place it in a carton at a picking location.

17. The method of claim 11, wherein instructing the picking mechanism at the picking station to perform the pick task includes:
instructing the picking mechanism to remove a second item from the first mobile storage unit and place it in a carton with the first item.

18. The method of claim 11, further comprising:
instructing, by the one or more processors, the robot to navigate horizontally along a support rail to a location of a defined buffer shelf;
instructing, by the one or more processors, the robot to transport a second mobile storage unit from the location of the defined buffer shelf to the staging area using the handling mechanism; and
instructing, by the one or more processors, the picking mechanism at the picking station to perform a second pick task including removing a second item from the second mobile storage unit and place the second item into a carton with the first item from the first mobile storage unit.

19. The method of claim 18, further comprising:
instructing, by the one or more processors, the robot to raise the handling mechanism vertically along a mast of the robot to a height of the defined buffer shelf;
instructing, by the one or more processors, the robot to extend the handling mechanism along a first horizontal direction to retrieve the second mobile storage unit from the defined buffer shelf; and
instructing, by the one or more processors, the robot to extend the handling mechanism along a second horizontal direction and lower the handling mechanism to place the second mobile storage unit at the staging area.

20. A system comprising:
one or more processors; and
a memory storing instructions that, when executed by the one or more processors, causes the system to perform operations comprising:
instructing a robot to remove a first mobile storage unit from a set of buffer shelves using a handling mechanism, the first mobile storage unit holding at least one item;
instructing the robot to place the first mobile storage unit at a staging area using the handling mechanism;
instructing a picking mechanism at a picking station to perform a pick task including removing a first item from the first mobile storage unit;
determining that the pick task has been completed at the picking station using the first mobile storage unit;
instructing the robot to remove the first mobile storage unit from the staging area using the handling mechanism; and
instructing the robot to place the first mobile storage unit on the set of buffer shelves.
